(19) United States
(12) Patent Application Publication
(10) Pub. No.: US 2008/0249936 A1
(43) Pub. Date: Oct. 9, 2008

(54) BILL PAYING SYSTEMS AND ASSOCIATED METHODS

(76) Inventors: Devin Miller, Bellevue, WA (US); Rebecca Miller, Bellevue, WA (US); Michael F. Buhrmann, Bellevue, WA (US)

Correspondence Address: PERKINS COIE LLP;PATENT-SEA, P.O. BOX 1247, SEATTLE, WA, 98111-1247, US

(21) Appl. No.: 12/061,611

(22) Filed: Apr. 2, 2008

Related U.S. Application Data
(60) Provisional application No. 60/910,141, filed on Apr. 4, 2007.
(60) Provisional application No. 60/912,110, filed on Apr. 16, 2007.
(60) Provisional application No. 60/944,670, filed on Jun. 18, 2007.

(51) Int. Cl. G06Q 20/00; G06Q 10/00; G06K 9/78

(52) U.S. Cl. 705/40; 705/30; 382/181

(57) ABSTRACT

Methods of paying user bills on behalf of a user are described. In one embodiment, the method includes receiving from a vendor a user bill having a user identifier, a vendor identifier, and a bill amount. The method further includes obtaining the user identifier, the vendor identifier, and the bill amount, associating the bill with the user based on the user identifier, and associating the bill with the vendor based on the vendor identifier. The method further includes determining whether the bill is payable, which includes comparing the bill to stored bill data associated with the user and the vendor. When the bill is payable, the method further includes obtaining funds from an account of the user, dispersing funds to the vendor to pay the bill and storing an indication of the paying of the bill.

### CROSS-REFERENCE TO RELATED APPLICATIONS INCORPORATED BY REFERENCE

This application claims priority from and incorporates by reference in their entireties, U.S. Provisional Application No. 60/910,141, filed on Apr. 4, 2007, U.S. Provisional Application No. 60/912,110, filed on Apr. 16, 2007, and U.S. Provisional Application No. 60/944,670, filed on Jun. 18, 2007.

### BACKGROUND OF THE INVENTION

Many individuals have a large number of bills that they have to manage and are forced to spend more and more time managing the payment of bills. As many people try to find more time in their lives, managing their bills can be an ever-increasing time commitment. Beyond the time commitment required to pay bills, vendors often impose late fees and/or penalties when an individual pays a bill late. Furthermore, in the event of a disputed bill, an individual may have difficulty in resolving the dispute with the vendor.

Online banking has become popular over the years. Online banking services often include a bill paying component that enables a user to pay bills. These services are generally designed with the principle in mind that the user operating the system is paying their personal bills. In existing online bill paying systems, it is up to the user to review the payment and determine if it should be paid. When setting up auto payments, the user is telling the system that they want this bill paid every time no matter what. Online bill paying systems, however, often cannot easily integrate expense accounting ledgers that are easily managed by the user. Moreover, online bill pay systems generally do not enable a user to easily change their address with multiple vendors, and generally do not assist a user in resolving vendor disputes.

Services that provide bill pay by a company on behalf of another person currently exist. However, such services generally only include a system for displaying bills to the bill owner. These systems are only meant to act as a data vault and approval system for the bill owner; they are more of a hybrid system that still depend on interaction from the bill owner or are designed simply as a display tool for the bill owner.

Traditionally, individuals looking for a personal bill paying service would contract with a professional marketing themselves as a bookkeeper, money manager or certified personal accountant. These professionals would manage the process of paying their clients' bills in their head, or on a combination of notes and word processing or spreadsheet documents. Primarily though, the management is in the professional's head. There are obvious shortcomings to this. The client could also utilize a personal financial management software system, but the management of this tool and upkeep is done by the individual client.

In providing the service of paying bills on behalf of another individual, an extremely time consuming and complex issue can be the management of vendor verification and disputes for that client. Bill paying services provided by professionals rely on that professional to manage the dispute for the client, determine the appropriate course of action and communicate with the client the resolution or course to resolution. Another drawback to professional bill-paying services is that the professional may not be able to easily change the client's address that is on file with the multiple vendors that bill the client.

Moreover, where a professional pays bills on behalf of a client, concerns may arise that the professional is not acting in the best interests of the client or in accordance with the professional's fiduciary duties. Such concerns may arise if the professional is incorrectly paying bills, such as by paying incorrect amounts or by paying unauthorized vendors. It can be difficult for a client to ascertain if their professional is always acting in the client's best interests.

In light of the aforementioned problems in online bill pay systems and professionally managed bill paying services, a bill paying system that solves the problems or minimizes their effect would have significant utility.

### SUMMARY OF THE INVENTION

A bill paying system in one embodiment can manage multiple aspects of the bill paying process. The bill paying system can cover a number of aspects of the bill paying process, including document management, bill review, payment processing, dispute management, an expense accounting ledger, process management and analytics. Beyond these seven aspects, the system can assist with various bill management scenarios. An individual will typically manage the payment of their own bills. However, it is increasingly common to employ an individual or professional firm (for example, a daily money manager, personal bookkeeper, or certified personal accountant) to manage the payment of bills and some or all of the seven aspects listed above. Therefore, a bill paying system should accommodate both individuals managing payment of their own bills and an individual or entity that manages the payment of bills of another individual or group of individuals.

A bill paying system in one embodiment can provide any combination of the seven aspects listed above, as well as additional aspects. The system can be configured to be used with numerous combinations of the seven aspects. The system can be used for any number of different purposes related to the management, review and processing of bills.

A bill paying system in one embodiment has a distributed model. The bill paying system can require that a user load paper and electronic bills or statements into the system so that the system can transcribe prevalent data from the bill for review by a bill review component. This bill review component can determine which bills should be payable and which should not be. The bills that the bill review component deems payable can be set to be automatically paid by the system. The bills that the bill review component determines should not be paid can be listed on an exceptions report that shows the unpayable bills and the reasons why the bills are unpayable. In one embodiment, individual paper or electronic bills can be loaded into the bill paying system. The system's distributed model of loading paper and electronic bills can work by setting three levels of entry into the system. The first level can be core processing centers. These centers are locations where paper bills of users are directed and loaded into the system. Each core location can be structured to receive a different type of bill or statement (for example, credit card statements, service bills, cell phone bills), or a core location can be structured to receive any type of bill or statement. The second level can be the licensee site. At this level, a license holder of the bill paying system (for example, a CPA firm, daily money manager, or wealth management firm) that is using the system to manage payment of bills for a group of individuals may receive client mail at their location and can load bills and/or statements directly into the system from their location via fax, email or other method. The final level can be the user. The end user of the bill paying system, the individual user managing their own bills can also directly load bills and/or statements into the system using a fax, email or other method from the location of their choice. This can be ideal for users who do not wish to move all or some of their bills to a core or licensee location.

In one embodiment, the bill paying system can use two subsystems to manage the distributed model. The first subsystem is an interface in the system that allows an operator at a core location, a licensee or an individual user to upload a document or bill and transform the data in the document or bill into a standard display bill. Each bill can have as many as ten data points that that the system can use in a bill review algorithm to determine if the bill should be payable. If the user loads a bill that is recognized by the bill paying system, the system captures known data points and loads the bill into the system. The system can give the user an alert that the loading worked. For those bills that are not recognized by the bill paying system, the system can allow the user to teach the system how to read the bill and where the pertinent data is. This gives the user the ability to load their own bills, which can be unique, and teach the bill paying system to remember the bills so that the system can recognize the bills the next time they are loaded. This process is described in more detail in the section entitled “Blocks 103 and 104 System & Method for Loading Bills and Creating a Standard Display Bill.”

The second subsystem used to manage the bill paying system's distributed model is the ability to automate the address change process and dictate a location where a user's paper and electronic mail will go. This subsystem is a change of address engine. When a user establishes an account, the bill paying system can allow the user to specify the bills the user wants the system to manage, the address that the bills are currently sent to and the location where the bills should be sent to be managed. If the user is going to be managed through a core processing center, the bill paying system can sort the bills by type and send them to the corresponding core location that can best manage the document, or the bill paying system can send all of the user's bills to one core location. If the user has five bills that the user wants to be managed by the bill paying system, the bills may end up being sent to five different core locations. After the system receives the user's specifications, the change of address subsystem can determine where to request to have the bills sent and then can file a change of address request with the vendor of each of the user's bills. A licensee can also use the bill paying system to request that client bills be sent to the licensee's desired location.

The subsystems described in further detail in the Detailed Description can make up various aspects of a bill paying system in one embodiment and applications that address the seven aspects as well as some of the different configurations of the bill paying system and how the configurations can be structured.

### BRIEF DESCRIPTION OF THE DRAWINGS

FIG. 1 is a block diagram illustrating a bill paying system in accordance with an embodiment of the invention.

FIG. 2 is a diagram illustrating processing of client bills in accordance with an embodiment of the invention.

FIG. 3 is a block diagram of a payable bill review process in accordance with an embodiment of the invention.

FIG. 4 is a block diagram of an operator management bill paying system in accordance with an embodiment of the invention.

FIG. 5 is a block diagram illustrating how a bill blog is accessed in accordance with an embodiment of the invention.

FIG. 6 is a block diagram illustrating an individual bill blog in accordance with an embodiment of the invention.

FIG. 7 is a flow diagram of a process for determining whether a bill is payable in accordance with an embodiment of the invention.

FIG. 8 is a block diagram illustrating interactions between banks and a bill paying system in accordance with an embodiment of the invention.

FIG. 9 is a block diagram illustrating an algorithm for determining whether a bill is payable in accordance with an embodiment of the invention.

FIGS. 10A through 15 illustrate display descriptions or web pages that the bill paying system may provide in accordance with embodiments of the invention.

FIG. 16 is a block diagram illustrating an audit control system in accordance with an embodiment of the invention.

FIG. 17 is a flow diagram illustrating a process for loading bills in accordance with an embodiment of the invention.

FIG. 18 is a flow diagram illustrating a process for recognizing loaded bills in accordance with an embodiment of the invention.

FIG. 19 is a flow diagram illustrating a process for teaching the bill paying system to recognize bills in accordance with an embodiment of the invention.

FIG. 20 is a flow diagram illustrating a process for address change requests in accordance with an embodiment of the invention.

FIG. 21 is a flow diagram illustrating a process for obtaining user feedback on address change requests in accordance with an embodiment of the invention.

FIG. 22 is a flow diagram illustrating a process for calculating a vendor rating in accordance with an embodiment of the invention.

FIG. 23 is a flow diagram illustrating a process for creating an accounting expense ledger in accordance with an embodiment of the invention.

FIG. 24 is a flow diagram illustrating a process for producing bill payment reports in accordance with an embodiment of the invention.

FIG. 25 is a flow diagram illustrating a bill paying system auditing process in accordance with an embodiment of the invention.

FIG. 26 is a flow diagram illustrating a transaction tracking process in accordance with an embodiment of the invention.

FIGS. 27 through 35 illustrate additional display descriptions or web pages that the bill paying system may provide in accordance with embodiments of the invention.

The headings provided herein are for convenience only and do not necessarily affect the scope or meaning of the claimed invention.

A portion of this disclosure contains material to which a claim for copyright is made. The copyright owner has no objection to the facsimile reproduction by anyone of the patent document or patent disclosure (including the Figures) as it appears in the Patent and Trademark Office patent file or records, but the copyright owner reserves all other copyright rights whatsoever.

### DETAILED DESCRIPTION

A bill paying system and process is described in detail below. In one embodiment, the process of paying bills can include nine steps: (1) obtaining a bill, and automatically changing the billing address on behalf of a client; (2) uploading of the bill to the system, which allows for further manipulation for processing purposes; (3) verification of the bill through review of historical data on client and vendor, comparisons to preferences and payment algorithms to determine payability; (4) processing any flagged bills through a vendor dispute system; (5) paying and processing of the bill; (6) tracking expenses utilizing an accounting ledger; (7) managing the flow of information through the process including user profiles and data management; (8) filing and management of the physical or electronic bill; and (9) producing reports that document the aforementioned steps.

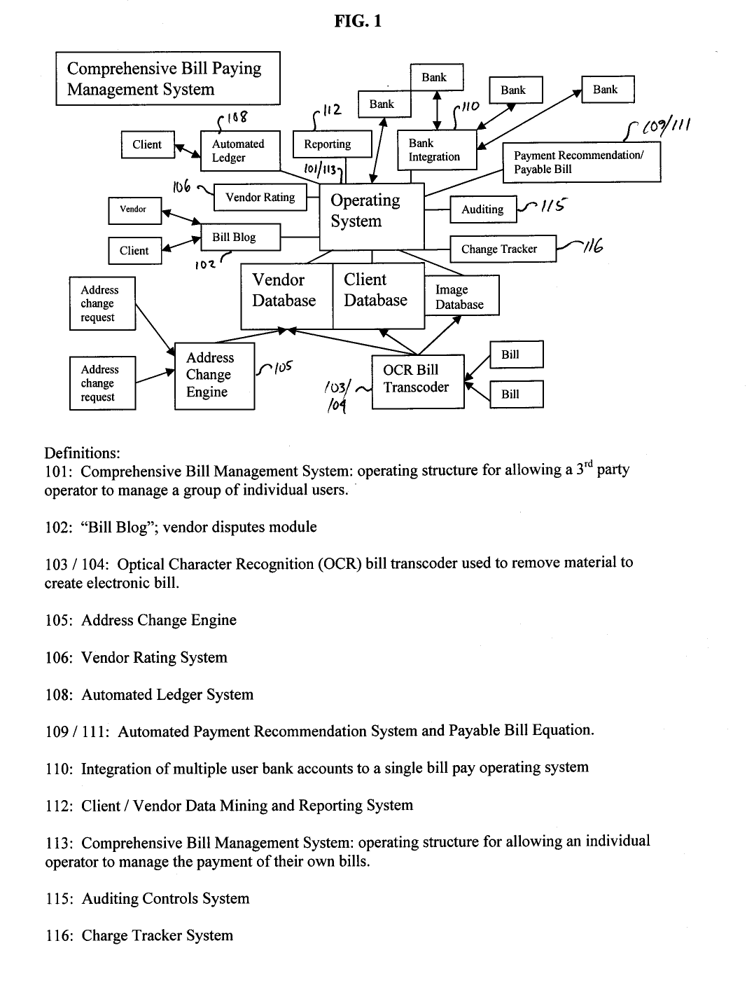

A bill paying system to perform some or all these functions is shown in FIG. 1. FIG. 1 shows some primary structural and operational pieces to manage the payment of bills for an individual by the individual or by a third party on behalf of the individual. The system is able to scale, has a modular nature, and has comprehensive capabilities integrated within the system. The scalability of the system includes the ability to create user profiles of various types, such as being able to assign an operator to manage groups of individuals of varying sizes or to assign an operator to an individual user (themselves) to manage the system. By being modular, the system includes a core operating or management system which controls databases and user profiles while subsystems are separated from the core and can be turned on or off based on the users' profiles. The comprehensive nature of the bill paying system allows it to automatically pay bills from the system, connect to outside data points, as well as manage work flows and to create reports.

The bill paying system of FIG. 1 can allow an operator, such as a financial administration partner or financial advisor, to manage bill paying for groups of individuals, such as clients of the financial administration partner or financial partner. Or, individual users may manage their own bill paying, i.e., manage bill paying for themselves.

As noted above, FIG. 1 shows an example of the overall bill paying system. Blocks 101 and 113 comprise systems for paying another person's bills and for allowing an individual user to manage the payment of their own bills. Block 102 is a customer/client bill blog. Blocks 103 and 104 are systems for creating a standardized display bill format. Block 105 is a system for changing a user's address with vendors. Block 106 is a system for rating vendors. Block 108 is a system for creating an expense accounting ledger. Block 109 is an automatic payment, approval, recognition and execution system. Block 110 is a component for connecting a third-party managed bill paying system to a client bank or several banks. Block 111 is a payable bill routine. Block 112 is a client and/or vendor data mining and reporting system. Block 115 is an auditing engine or subsystem. Block 116 is a transaction tracking system. These blocks are discussed separately below.

Various examples of the invention will now be described. The following description provides specific details for a thorough understanding and enabling description of these examples. One skilled in the art will understand, however, that the invention may be practiced without many of these details. Additionally, some well-known structures or functions may not be shown or described in detail, so as to avoid unnecessarily obscuring the relevant description.

The terminology used in the description presented below is intended to be interpreted in its broadest reasonable manner, even though it is being used in conjunction with a detailed description of certain specific examples of the invention. Certain terms may even be emphasized below; however, any terminology intended to be interpreted in any restricted manner will be overtly and specifically defined as such in this Detailed Description section.

Blocks 101 and 113 Bill Paving System & Method for Paying Another Person's Bills and for Allowing an Individual User to Manage the Payment of Their Own Bills

Overview

A bill paying system and method for paying another person's bills is a combination of multiple pieces configured for managing the payment of bills by someone other than the bill owner. A user profile setting assigns an operator to manage the bill pay process for a group of individuals. Based on this setting, additional modules are activated such as audit controls and an ability to manage multiple bank accounts from one operator. Overall, this setting within the system defines the interaction with the separate modules and how the process will be managed.

The bill paying system is comprised of an interactive client reporting platform designed to allow the client and those assigned by the client the ability to review data pertinent to managing their bills. The system also includes a work order management system designed to audit, review and provide the operator of the system a method for overseeing the process of paying the clients' bills. There is a built-in database management system and records management system that allows for easy integration of client documents and records. The data in these systems is also structured in a way that is readable by a system, which in turn allows the client to search for data and compare results with the aggregate data of all clients in the system. This searchable data structure is also meant to allow users to run customized reports and searches of their data as well as manage their personal ledger system.

The bill paying system described herein is designed to pay bills for a large number of individuals on their behalf, and allows the operator the ability to not only display client data but primarily to capture client preferences, notes, records; vendor disputes, improve client data security, automate and improve system auditing capabilities, as well as automating some of the more basic yet essential tasks, including the creation of a personalized ledger. This system manages and in places automates the process of paying bills for another individual. A work flow is described below, including what takes place, what work should be done at each step, and detail regarding certain subsystems.

The bill paying system employs a backend “operating system” to perform managed bill pay functions. The managed bill pay functions may consist of several features or subsystems noted above, such as a database of client documents, automated methods to populate those databases, an automated payment recommendation system, a vendor dispute system, a vendor database, as well as the ability to gather data in the databases and develop reports for presentation to the user or system administrator. These subsystems when integrated together provide a structure that increases client functionality in a bill paying platform and allows for complete management of the bill paying process from beginning to end, making it easier for clients to manage disputes with vendors as well as making it easier for the user to gain insight into their personal finances and vendors.

This bill paying system is usable by an individual consumer to manage the payment of their personal bills. Overall one result of the system is the payment of client bills to their personal vendors. In other bill payment software numerous features are difficult to manage for the user and are fragmented from the bill paying system. In the present managed bill paying system, the system integrates paper bills and e-bills, integrates vendor information and helps manage vendor disputes for clients. The system includes a vendor database that gathers data from the user on their vendors and stores the data. The data can be used in conjunction with aggregate data from other client vendors. This database is used to help manage processes, manage vendor disputes and helps in creating custom algorithms to determine if a client bill meets requirements to be paid.

Once a bill arrives at a sorting station via email or paper mail, it is transferred into the bill paying system and integrated in a way that allows the pertinent data to be copied and added to the system databases and allows it to be reviewed against a set of parameters to determine if the bill is payable based on those parameters, needs further review, or is currently unpayable and why. From there, the client can either have the bill paid or submitted to the vendor dispute system. Within the vendor dispute system the bill is sent into a ticketing area where the client can review the vendor database for similar issues and how other users resolved them, either by vendor or industry or both. The vendor dispute engine can also be used as a gateway to the vendor contact information and website listing their contact information.

On the user interface side the bill paying system provides data that shows the client detailed reports on each payee they have listed. These reports include historical data of payments, visual representations of payments made, a list of disputes expired and outstanding as well as vendor contact information.

The following discussion provides a brief, general description of a suitable computing environment in which the invention can be implemented. Although not required, aspects of the invention are described in the general context of computer-executable instructions, such as routines executed by a general-purpose computer, e.g., a server computer, wireless device or personal computer. Those skilled in the relevant art will appreciate that aspects of the invention can be practiced with other communications, data processing, or computer system configurations, including: Internet appliances, hand-held devices (including personal digital assistants (PDAs)), wearable computers, all manner of cellular or mobile phones, multi-processor systems, microprocessor-based or programmable consumer electronics, set-top boxes, network PCs, mini-computers, mainframe computers, and the like. Indeed, the terms “computer,” “server,” and the like are generally used interchangeably herein, and refer to any of the above devices and systems, as well as any data processor. Also, the terms “system” and “subsystem” are at time used interchangeably herein.

Aspects of the invention can be embodied in a special purpose computer or data processor that is specifically programmed, configured, or constructed to perform one or more of the computer-executable instructions explained in detail herein. Aspects of the invention can also be practiced in distributed computing environments where tasks or modules are performed by remote processing devices, which are linked through a communications network, such as a Local Area Network (LAN), Wide Area Network (WAN), or the Internet. In a distributed computing environment, program modules may be located in both local and remote memory storage devices.

Aspects of the invention may be stored or distributed on computer-readable media, including magnetically or optically readable computer discs, hard-wired or preprogrammed chips (e.g., EEPROM semiconductor chips), nanotechnology memory, biological memory, or other data storage media. Indeed, computer implemented instructions, data structures, screen displays, and other data under aspects of the invention may be distributed over the Internet or over other networks (including wireless networks), on a propagated signal on a propagation medium (e.g., an electromagnetic wave(s), a sound wave, etc.) over a period of time, or they may be provided on any analog or digital network (packet switched, circuit switched, or other scheme).

The invention employs at least one computer, such as a personal computer or workstation, with at least one processor, and is coupled to one or more user input devices and data storage devices. The computer is also coupled to at least one output device such as a display device, and may be coupled to one or more optional additional output devices (e.g., printer, plotter, speakers, tactile or olfactory output devices, etc.). The computer may be coupled to external computers, such as via an optional network connection, a wireless transceiver, or both.

The input devices may include a keyboard and/or a pointing device such as a mouse. Other input devices are possible such as a microphone, joystick, pen, game pad, scanner, digital camera, video camera, .wav file and the like. The data storage devices may include any type of computer-readable media that can store data accessible by the computer, such as magnetic hard and floppy disk drives, optical disk drives, magnetic cassettes, tape drives, flash memory cards, digital video disks (DVDs), Bernoulli cartridges, RAMs, ROMs, smart cards, etc. Indeed, any medium for storing or transmitting computer-readable instructions and data may be employed, including a connection port to or node on a network such as a local area network (LAN), wide area network (WAN) or the Internet. As will become apparent below, aspects of the invention may be applied to any data processing device. For example, a mobile phone may be secured with only the addition of software stored within the device—no additional hardware is required. The software may be stored within non-volatile memory of the phone, possibly even within the subscriber identity module (SIM) of the phone, or stored within the wireless network.

Aspects of the invention may be practiced in a variety of other computing environments. For example, a distributed computing environment including one or more user computers in a system, each of which includes a browser module. Computers may access and exchange data over a computer network, including over the Internet with web sites within the World Wide Web. User computers may include other program modules such as an operating system, one or more application programs (e.g., word processing or spread sheet applications), and the like. The computers may be general-purpose devices that can be programmed to run various types of applications, or they may be single-purpose devices optimized or limited to a particular function or class of functions. Web browsers, or any application program for providing a graphical or other user interface to users, may be employed.

At least one server computer, coupled to a network, performs much or all of the functions for receiving, routing and storing of electronic messages, such as web pages, audio signals, and electronic images. Public networks or a private network (such as an intranet) may be preferred in some applications. The network may have a client-server architecture, in which a computer is dedicated to serving other client computers, or it may have other architectures such as a peer-to-peer, in which one or more computers serve simultaneously as servers and clients. A database or other storage area coupled to the server computer(s) stores much of the web pages and content exchanged with the user computers. The server computer(s), including the database(s), may employ security measures to inhibit malicious attacks on the system, and to preserve integrity of the messages and data stored therein (e.g., firewall systems, secure socket layers (SSL), password protection schemes, encryption, and the like).

The server computer may include a server engine, a web page management component, a content management component, and a database management component. The server engine performs basic processing and operating system level tasks. The web page management component handles creation and display or routing of web pages. Users may access the server computer by means of a URL associated therewith. The content management component handles most of the functions in the embodiments described herein. The database management component handles storage and retrieval tasks with respect to the database, queries to the database, and storage of data such as video, graphics and audio signals.

### DETAILED DESCRIPTION OF A SUITABLE EMBODIMENT

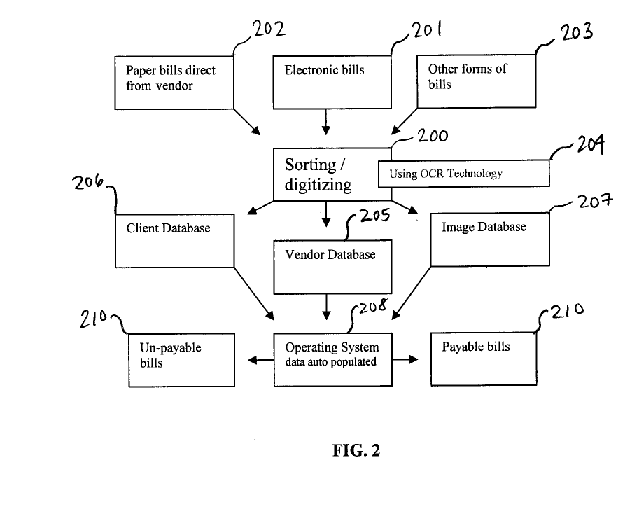

As shown in FIG. 2, bills can enter the bill paying system from a number of points: electronic bills 201 (e.g., an email request or digital image), redirected physical paper mail 202, as well as physical paper mail provided by the client, or via other means 203. An individual that manages the paying of bills for a client or group of clients can submit bills for processing, or an individual can submit their own bills. From there this “mail” is collected into one central or multiple sorting stations 200 and converted into a digital form, such as by being scanned to produce an image file. A sorting station can be configured to receive only a particular type of mail or any type of mail. Optical character recognition (OCR) software 204 may be used to find and extract information to be loaded into an internet based management system. At this point, the bills are loaded and filed by client and according to vendor identifiers or data fields. The clients as well as an operator are able to access this internet based database to review statements current and past. The mail is sorted by client and reviewed against a subsystem to determine any missing or irregular mail. The OCR system and corresponding software program extracting data from each bill loads the data into three databases, one for vendor information 205, one for client information 206 and one for bill images per client 207. Within the client database there is a database of client preferences, operator notes, averages of previous and expected future payments as well as expected arrival and payment dates, as well as personal ledger profiling and other information. The operating system 208 receives data from the client database 206, the vendor database 205 and the image database 207 to determine which bills are payable 209 and which bills are not payable 210.

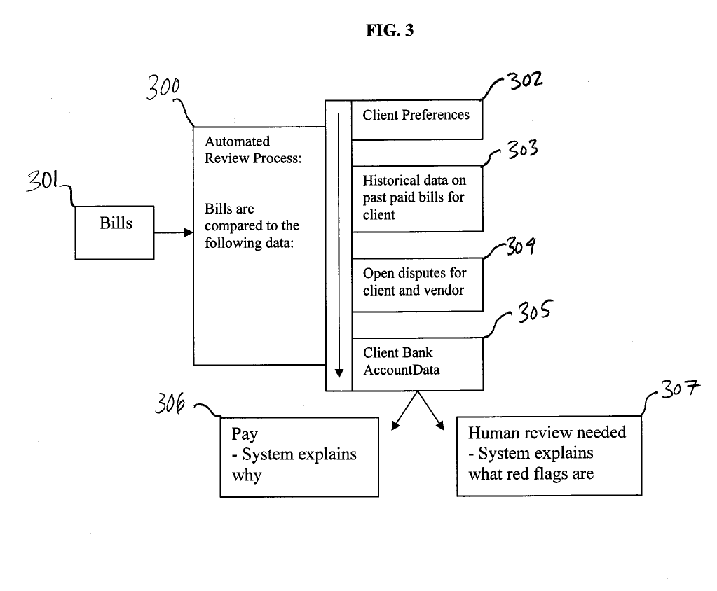

As shown in FIG. 3, an automated bill paying system 300 can review the incoming bills 301 against historical data, client preferences 302 and aggregate data from the system and then either recommend each bill for payment 306 to the operator using client bank account data 305 or flag the bill and submit it to a file for further review 307. For the payable bills, the operators can then go ahead and submit for payment. The system may also produce a record indicating why the bill was paid, where this record is provided for the client's option to view. For the paid bill, the client is alerted on the front or starter page for the client of the management system that the bill is paid and what the corresponding amount has been. For unpaid bills that require further attention by the system operator, a subsystem notes changes to the account as well as logs disputes or trouble with a particular vendor 304. These notes are made available to the client and other operators. The operator communicates via email, through the bill paying system itself via a vendor dispute subsystem, or over the phone to collect and pass along information potentially required to overcome the dispute. If this process is successful, the bill is catalogued per the payable bill process.

On an ongoing basis, the client presentation subsystem is able to provide current and past data and employs a database to sort bills by month. Each digital image of a paid bill is matched to a corresponding vendor and amount paid and displayed to the client. This data is sorted by month and then by year. Each operator can be assigned to multiple clients and is thus given the ability to sort by client and manage each client individually from one bill paying system. The ability also exists in the bill paying system to change the user profile so that a user is defined as an operator with one client assigned to them and this client is the user themself. In this setting the user is managing their own account and the module settings are adjusted to reflect this change. An administrator is given full access to both operator and client views as well as the ability to create and terminate client and operator accounts when needed.

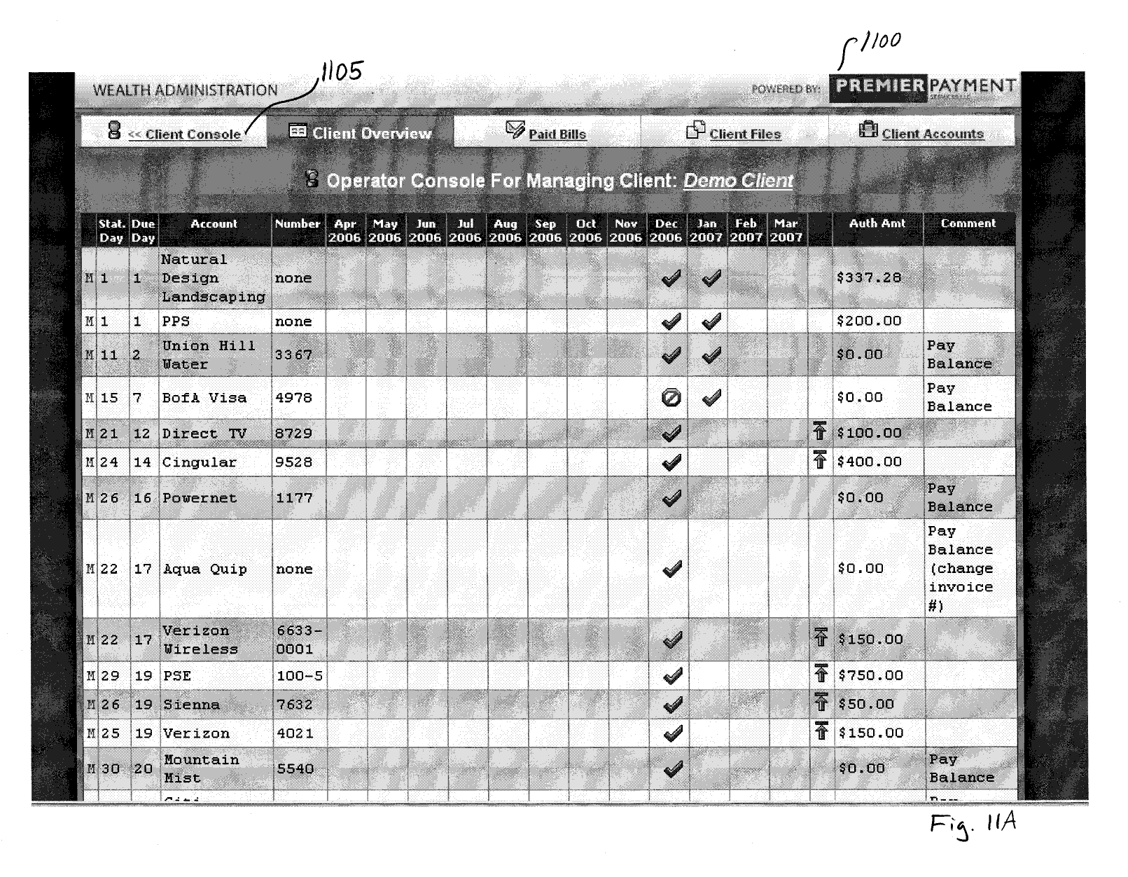

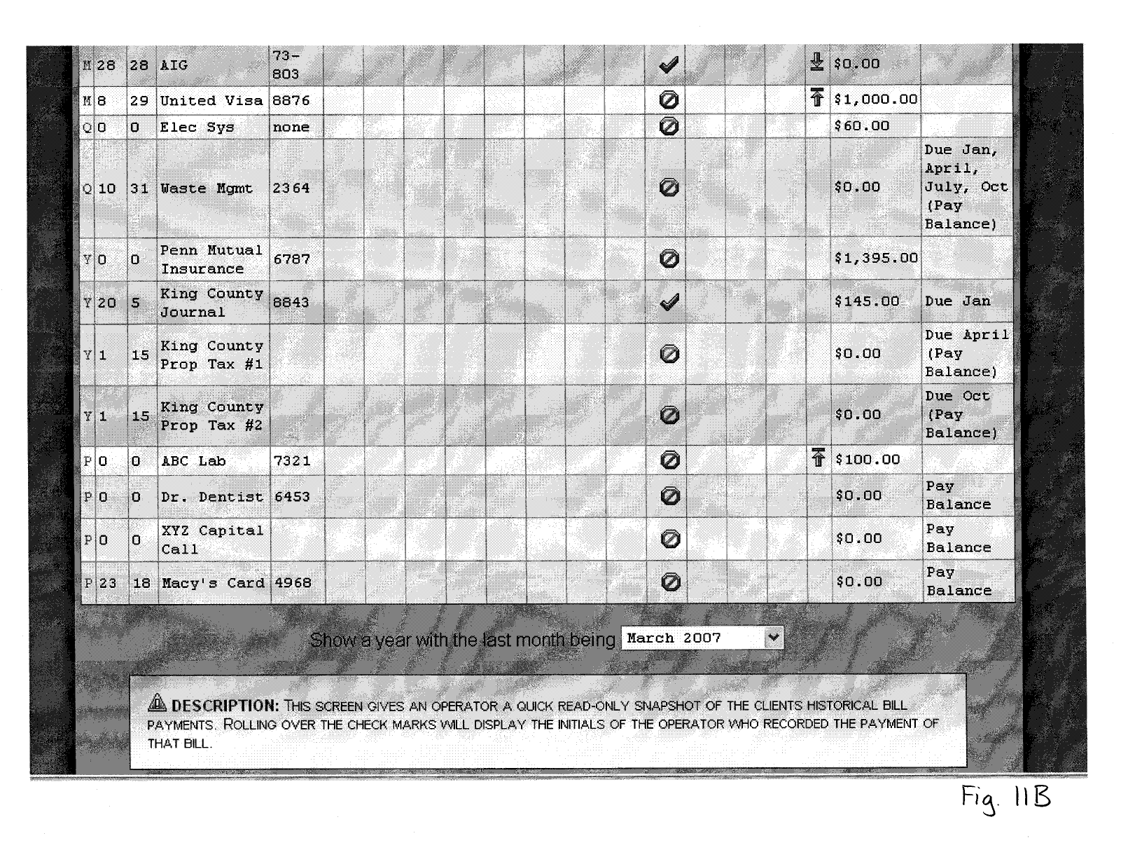

For the client reporting section, the client has the ability to log in to a secure site and see via a web browser current and historical bills, current payments and historical payments, open and view attached reports or files, view in depth vendor reports containing data on that vendor particular to the client and also view vendor disputes relating to that client. There is also a module that feeds into the reporting system to create a personal income and expense ledger. FIGS. 10A and 10B show an example of the client page 1000, which can also be accessed by an operator by selecting a “Client Console” link 1105 shown in FIG. 11A.

The screens or web pages presented herein provide facilities to present information and to receive input data, such as a form with fields to be filled in, pull-down menus or entries allowing one or more of several options to be selected, buttons, sliders, hypertext links or other known user interface tools for receiving user input. While certain ways of displaying information to users is shown and described with respect to certain Figures, those skilled in the relevant art will recognize that various other alternatives may be employed. The terms “screen,” “web page” and “page” are generally used interchangeably herein.

When implemented as web pages, the screens are stored as display descriptions, graphical user interfaces, or other methods of depicting information on a computer screen (e.g., commands, links, fonts, colors, layout, sizes and relative positions, and the like), where the layout and information or content to be displayed on the page is stored in a database. In general, a “link” refers to any resource locator identifying a resource on a network, such as a display description provided by an organization having a site or node on the network. A “display description,” as generally used herein, refers to any method of automatically displaying information on a computer screen in any of the above-noted formats, as well as other formats, such as email or character/code-based formats, algorithm-based formats (e.g., vector generated), or matrix or bit-mapped formats. While aspects of the invention are described herein using a networked environment, some or all features may be implemented within a single-computer environment.

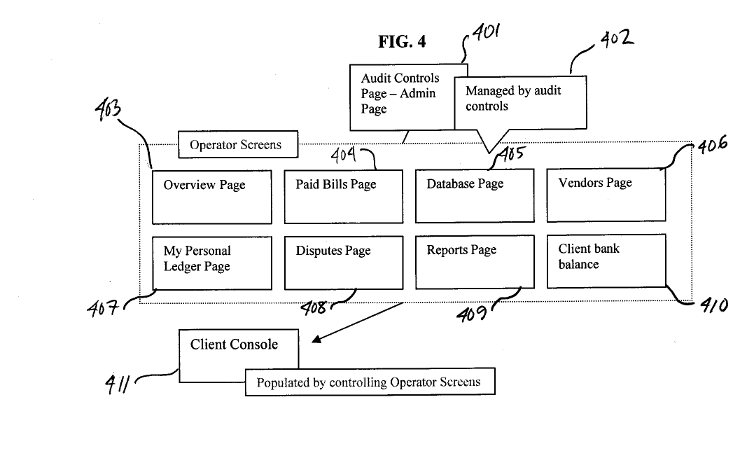

How a bill is determined to be payable is configured on an Audit page of an operator system, an example of which is shown in FIG. 4. When the bill paying system explains why a bill is payable or un-payable, it references this equation and preferences and lists the aspect(s) of the equation that caused it to fail or pass. Some details on FIG. 4 as follows (note: the below examples are described as ‘pages’ in a software system.) Each page contains the data and systems as described below. The actual system can be laid out in a manner that best displays the information needed for the users. The pages below are meant to describe the high level architecture requirements.

Administrator/Audit Controls Page 401: This page 401 includes a system that is managed by the system administrator. On this page 401 is the ability to create new users (operators, advisor and clients) as well as set preferences for auditing 402 the bill paying system. The administrator can set rules on this page 401 such as: 1) all new vendors added must be approved; 2) all account numbers entered are matched against those on the bill before payment is made—any discrepancies to this rule will be recorded here in a log; 3) any payment request over a certain amount will be logged and marked in this section; and 4) the system will also automatically log all usage of the system and by which user based on preset criteria.

Overview Page 403: This page 403 displays historical data of previous payments made for each individual client. This page 403 shows who paid the bill, what the amount was, when it was paid and any notes or disputes. This page 403 is meant to provide a historical record of each payment and the process involved. See the example of FIGS. 11A and 11B.

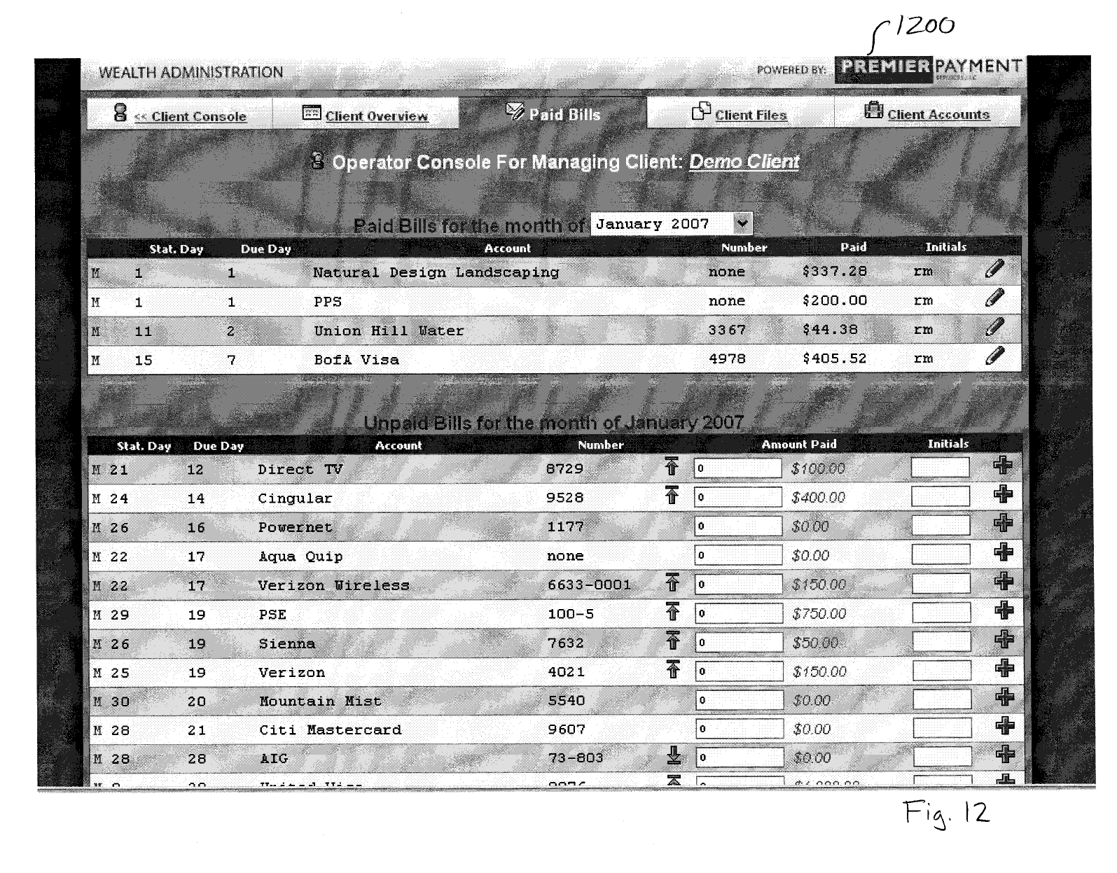

Paid Bills Page 404: This is the page 404 where the review process occurs to determine if a bill meets requirements to be paid or should be reviewed further. This page 404 is able to be set to view an individual client or a group of clients. This is where client's bills are paid and where the connection to the clients' bank account is made. See the display description 1200 of FIG. 12.

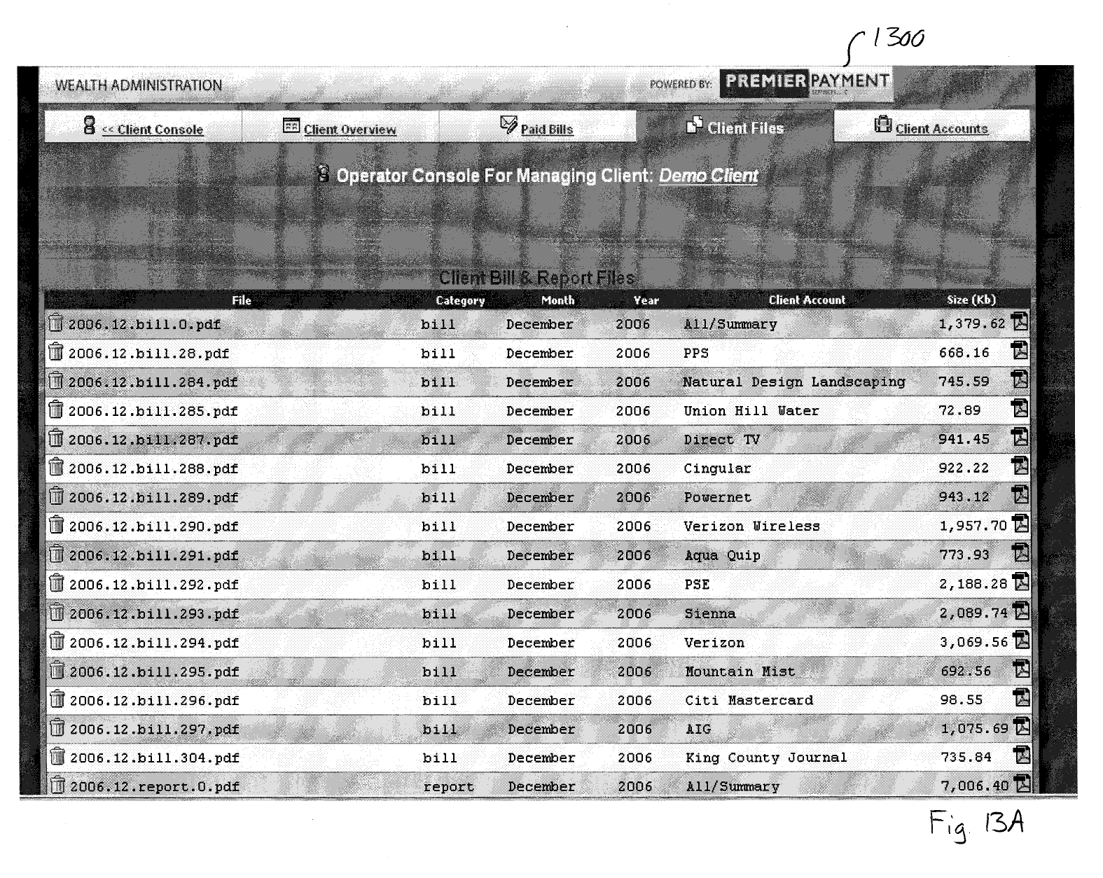

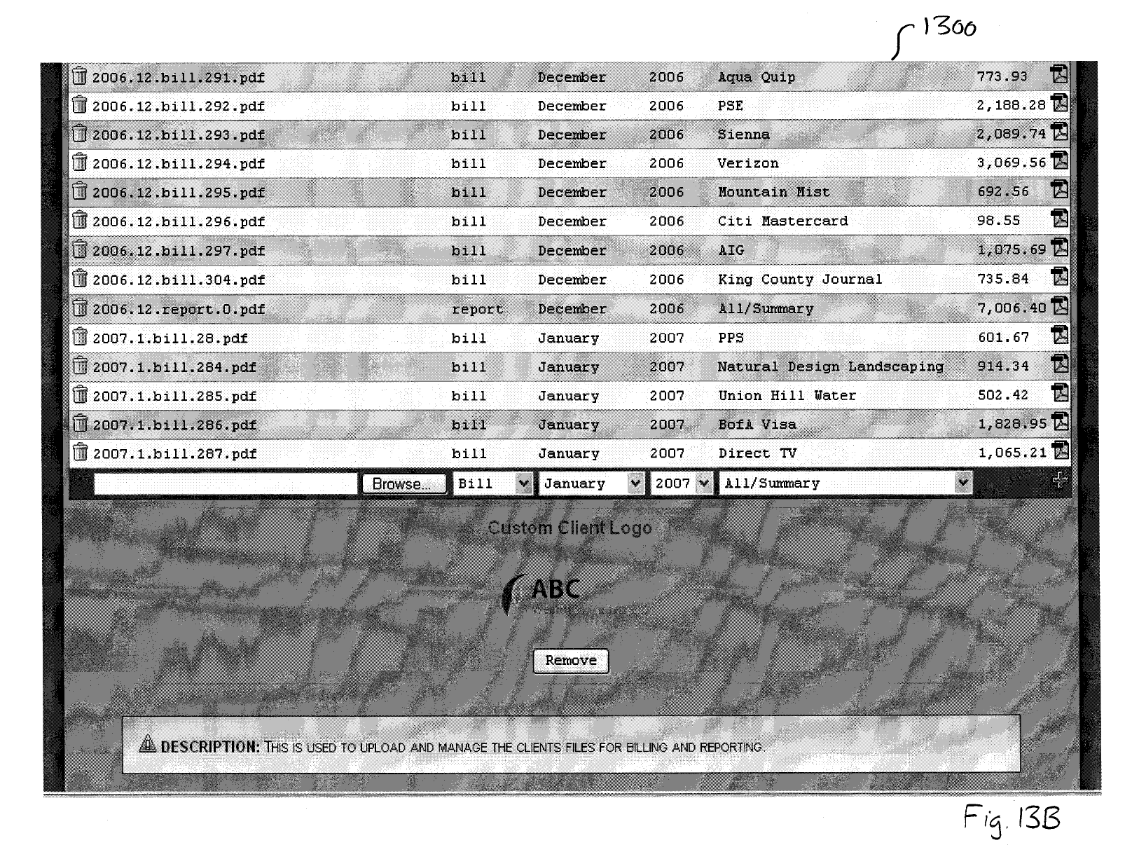

Database Page 405: This page 405 manages the database of files associated with each client. This page 405 displays individual client data but the operator can choose from a list of clients to view data on. See the display description 1400 of FIGS. 14A and 14B. This is also where new files are uploaded into the system and other files or images are loaded to be displayed in other sections of the system. See the display description 1300 of FIGS. 13A and 13B which shows a list of bills received for a client, and the ability to click on the displayed “PDF” icon to see an image of the scanned bill.

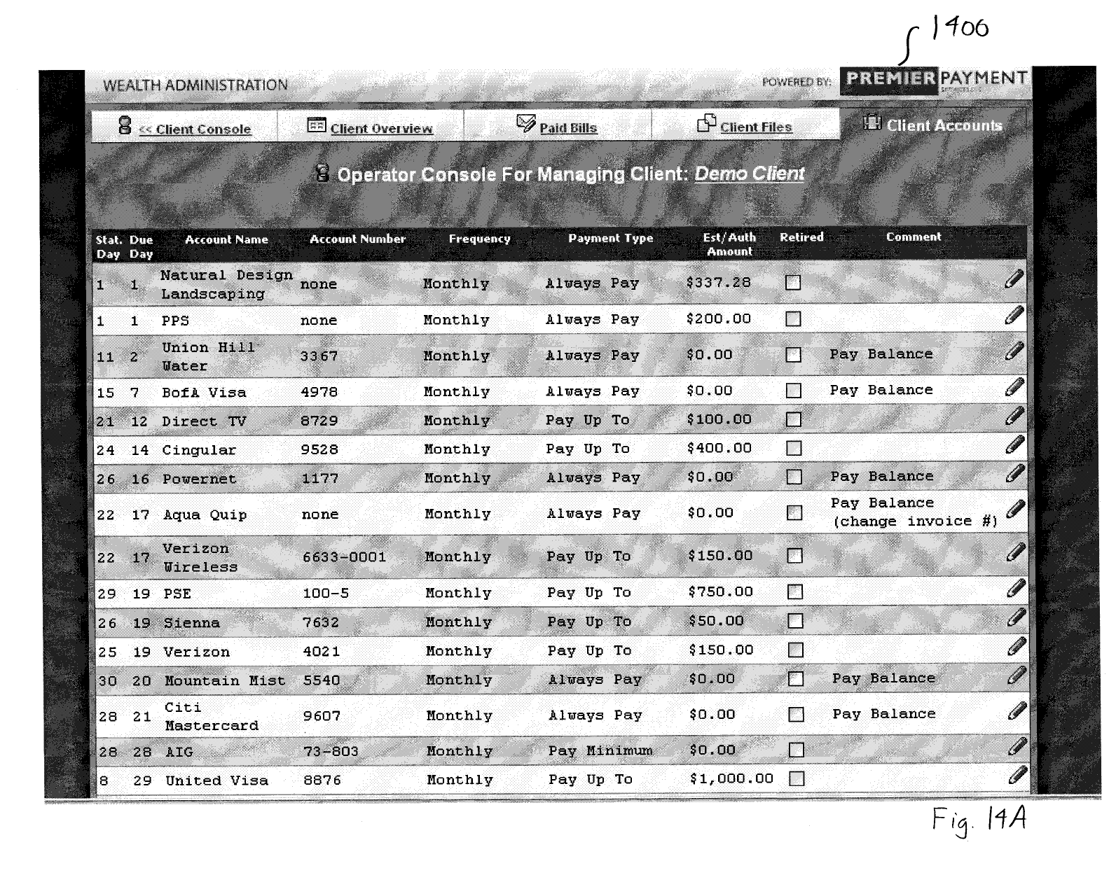

Vendors Page 406: This page 406 is a general system list of all vendors. This page 406 can be configured to display either the vendors associated with an individual client and then also add new vendors and their related data, or the operator can view a master list of vendors and their related data. This page 406 references the database of vendors that the system can access. When an operator assigns a vendor to a client they reference the database on this page 406 to load vendor data and then attach the individual client data. The operator can also load in new vendors to the system which will then appear on the audit page 402 for approval before any individual client can be assigned to them. Notes on any vendor disputes or vendor preferences are loaded and also available for future viewing on this page 406 as well. FIG. 15 shows an example of a report for a specific vendor that the system may produce and provide to a client.

Disputes Page 408: This page 408 operates similar to the vendors page 406. It can display disputes in relation to a particular client or it can display information relating to a particular vendor. This page 408 is where the operator goes to record a vendor dispute and communicate with a client about the progress of a dispute. The notes on these disputes are also available to the client on the client page 411.

Client Bank Balance Page 410: This page 410 makes a connection to the clients' bank account and displays account balances and recent activity.

Reports Page 409: If a client or operator wishes to run a report based on data contained in the system this is the page 409 they reference. Again, a report can be run on an individual client or on the aggregate of data throughout all clients in the system. Some examples are: 1) vendor reports and historical vendor data per client or per vendor, including but not limited to monetary and usage; 2) dispute reports based on individual clients, the client vendors overall or on a particular vendor in the entire system; 3) averaged reports based on total amount spent per vendor or category of vendors in the entire system; and 4) a link to a personal ledger module 407—this part of the reports page allows the user to review expense and income data.

Client Console Page 411: The pages 411 visible to the operator are used to collect and process data that will be displayed to the client on the client console page 411. This data is the end result data of information processed through the operator system. Also, in a reports function found on the client console 411, the data is pulled from operator pages such as vendor pages 406, reports pages 409, etc. The client is able to interact with the system at this point regarding things such as change of preferences and contacting the operator assigned to their account. See the display description 1000 of FIGS. 10A and 10B.

An element of this system is the manner in which the user profiles are configured and managed. Due to the modularized nature of the system, depending on the user profile, different aspects of the systems can be turned on or off as well as being adaptable based on the user profile. These profiles are explained below:

Administrator: This user manages the system, creates new users, oversees audit controls/rules and manages the databases.

Client/User: The client (sometimes referred to as the user in this document) is the user who owns the bills that are being managed.

Operator: This is the person that is managing the payment of bills for the client. In addition, the system can be structured so that an operator manages one client, themselves. This is described later as the Managed Bill Pay structure.

Advisor: This is a limited access Client. They are typically a personal advisor to a client in the system and are allowed limited access to different portions of that clients information. An advisor can be assigned to a group of Clients as well.

Manager: A manager has limited administrator access and controls a group of operators. The manager can control a limited amount of audit controls and user creation controls.

As noted above, this system includes a software component that makes data available to clients via the World Wide Web or other network. The operator system that manages the process and populates the client page can be accessed via a closed intranet system managed by a central database or packaged as stand alone software available for individual use. It can also be made available based on a application service provider (ASP) model or a software as a service (SaaS) model.

Overall, aspects of the systems & associated methods use technology (either online or paper) to help users (end clients) pay their bills. This system allows third-party bill payment. The system includes: 1) database management system to organize the vendors, client, and image databases; 2) connections with a document management system and OCR in relation to a database structure to help populate and automate the bill pay system; 3) a modular structure of subsystems that can be used by themselves from outside the core operating system as well as be turned on or off (or parts of based on the user profile; 4) a comprehensive approach to the bill pay process covering the 9 steps noted above; 5) back office process (including the screens noted above) that define the core operating system; 6) a scalable user profile system that allows for different levels of users as well as the ability to assign management of varying groups of users to one operator; 7) audit controls and rules; and 8) connection with the required financial institutions to move information and requests in and out of the core operating system and databases.

### Block 102 Customer/Client Bill Blog

Overview

A subsystem is described below that provides a blog to have a customer/client dialog around a person's bill(s) including vendor disputes. The subsystem helps to automate the dispute process by providing a platform of communication, recording responses by client and the service provider, cataloging disputes and searching through the data for relevant and comparable situations.

### DETAILED DESCRIPTION OF SUITABLE EMBODIMENT

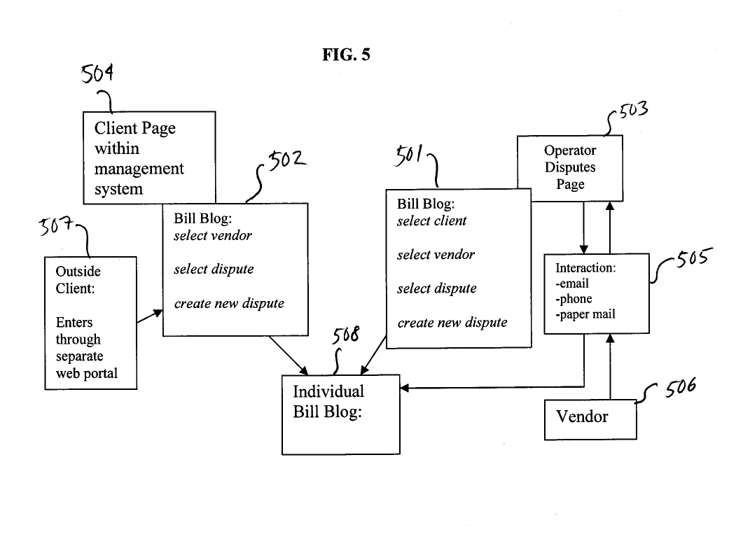

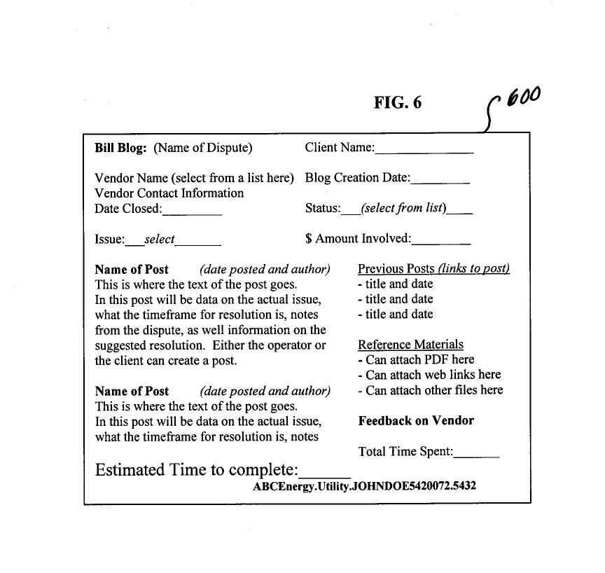

As shown in FIG. 5, a bill blog 508 is a vendor dispute resolution process built into a software program designed to manage the task of paying bills for groups of varying sizes. The bill blog 508 manages the records of disputes and vendor related issues filed by the client into the system or on behalf of the client. The bill paying system permits multiple people involved in the dispute to manage the dispute from beginning to end in one system, which is then kept as a historical or legal record. Once these disputes are catalogued into the bill paying system, the operator of the program uses the bill blog 508 to record notes of the process of resolving or researching the dispute. These notes are then readable by the client throughout the process and the client can post their response or the response is automatically posted from the operator. Once the resolution is resolved, the bill blog 508 entry is finalized and entered into the records of the bill blog database based by client. The results of these entries can be searched for facts about the client as well as generalized data about vendors.

While managing the payment of bills on behalf of multiple individuals, issues with and disputes regarding individual client vendors occurs with a high degree of regularity. This system allows the operator of the system that is paying the bill the ability to fully manage 501 the process on behalf of the client using the operator dispute pages 503. At the onset of the dispute, the operator or client creates an initial post within the bill blog 508 in the overall bill pay system detailing the overall dispute. At this point an automatic date stamp is placed in addition to a vendor being associated to the dispute. Also, a proposed solution method is created and posted as well. This information is then posted by the system to the general bill blog 508 and made available to the client and connected to the general bill blog database.

As the dispute is worked to a resolution, the operator(s) 503 as well as the client can continue to post updates 502 to the system and review the postings for prior information using the client pages 504. At the completion of the dispute, the operator inputs whether the dispute was resolved and then marks a category for how the dispute will be recorded ongoing, such as if it is still being disputed or closed.

Within the bill paying system, there is a separate area designated as the vendor dispute section in which all bill blogs are stored. These blog entries are available on demand via the internet to the client and operator through the management system 504 or directly through an internet web portal 507, as well as available to the vendor(s) 506 and as a stand alone service to outside clients via an internet web portal. These entries can be viewed by vendor, by client, as part of a more detailed vendor report, by dispute type or in any other manner deemed appropriate. Within the operator vendor dispute section, there are also additional capabilities related to the management of resolving future disputes on the behalf of additional clients. Past blog entries can be reviewed individually or collectively for relevant information such as disputes per client, disputes per vendor for all clients, overall reports on a group of or selective vendors/clients, resolution reports or outstanding dispute reports, as well as any other data that can be collected from the blog entries. Data such as in the form of a wav file, email correspondence, scanned documents (paper mail, or paper correspondence), and any other form of dispute documentation 505 can be attached to the database or individual bill blog. See FIG. 5.

Overall, the system employs a managed database of records and disputes. This system will allow the client to access the files via a secure internet connection. The operator will use a similar connection method.

Both the client and the operator can access the system. This can be done from the pages listed above. Once they choose to open the bill blog sub-system then they are diverted to a page that will allow them to select the information above. Once this information has been entered, they are then diverted to an information page 600, such as that shown in FIG. 6. In addition, this information is collected for the input into the vendor database for later data mining and a feedback loop into the payable bill algorithm. Also, the client is able to be contacted via email, text message, phone, etc, when the blog is updated.

### Blocks 103 and 104 System & Method for Loading Bills and Creating a Standard Display Bill

Overview

Bills today come in a never ending assortment of shapes, sizes and formats. They can be paper bills, electronic or ebills delivered via an email or via a data link such as an HTML webpage or even hand written documents. For each delivery method, a system can be created for collecting data from bills, but each system would be different due to the differences in delivery methods. Also, the format and structure of data contained in bills varies greatly. Existing bill formats do not allow a user or a third party the ability to easily capture data from them either individually or in a group of bills. There is a tremendous amount of data contained in a single bill and in order to easily extract that data and use it, a standardized data structure must be created. Subsystems and methods are described below for loading bills of various formats into the bill pay system, organizing bill data into a standardized data structure, and reformatting the bills into a standardized display format.

### DETAILED DESCRIPTION OF SUITABLE EMBODIMENT

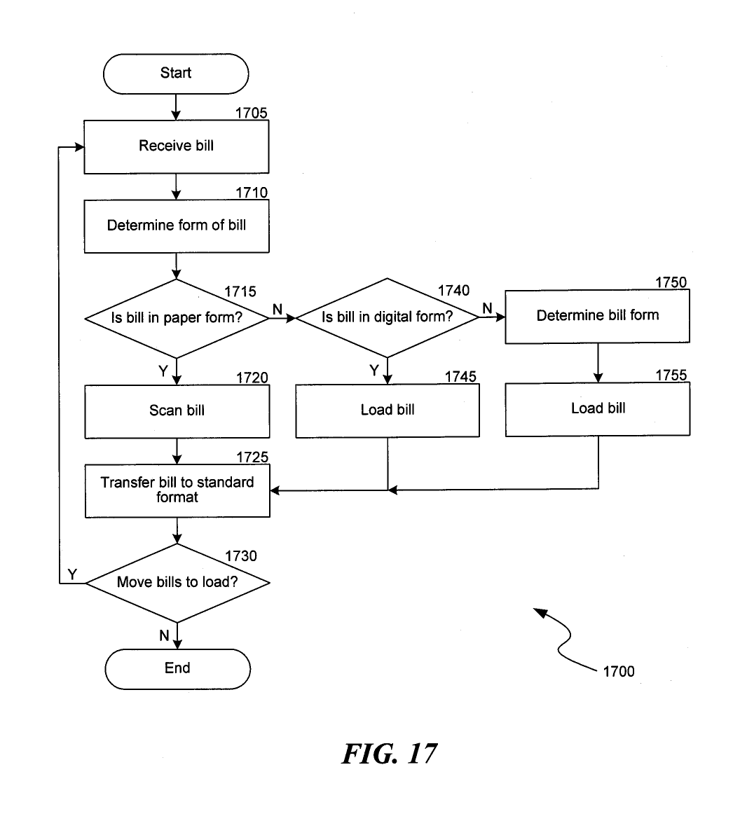

FIG. 17 is a flow diagram of a process 1700 for loading bills into the system. Bills can enter the process from a number of points: e.g., an email request, a digital image, redirected physical paper mail, physical paper mail provided by the client, or via other means. An individual that manages the paying of bills for a client or group of clients can submit bills for processing, or an individual can submit their own bills. From there this “mail” can be collected into a central or multiple sorting stations and converted into a digital form, such as by being scanned to produce an image file. A sorting station can be configured to receive only a particular type of mail or any type of mail.

At step 1705 bills are received into the system. The system determines the form of the bill at step 1710. In step 1715, the system determines if the bill is in paper form, and if so, the system scans in the bill at step 1720. If the bill is not in paper form, in step 1740 the system determines if the bill is in digital form, and if so, the system loads the bill at step 1745. For bills in forms other than paper or electronic, the system determines the form of the bill in step 1750 and loads the bill in step 1755. In step 1725, the system transfers the bill to a standard display format. In some embodiments, the standard display format has eight required data points: client name, client account number, client address, due date, amount due, payee name, payee address, and payee phone number. The standard display format can also have other data points, such as late fee information and other information. For bills in paper form, optical character recognition (OCR) software may be used to find and extract information from the bill to be loaded into the system. In step 1730, the system determines if there are more bills to be loaded. If so, the system repeats process 1700 beginning at step 1705 until there are no more bills to be loaded.

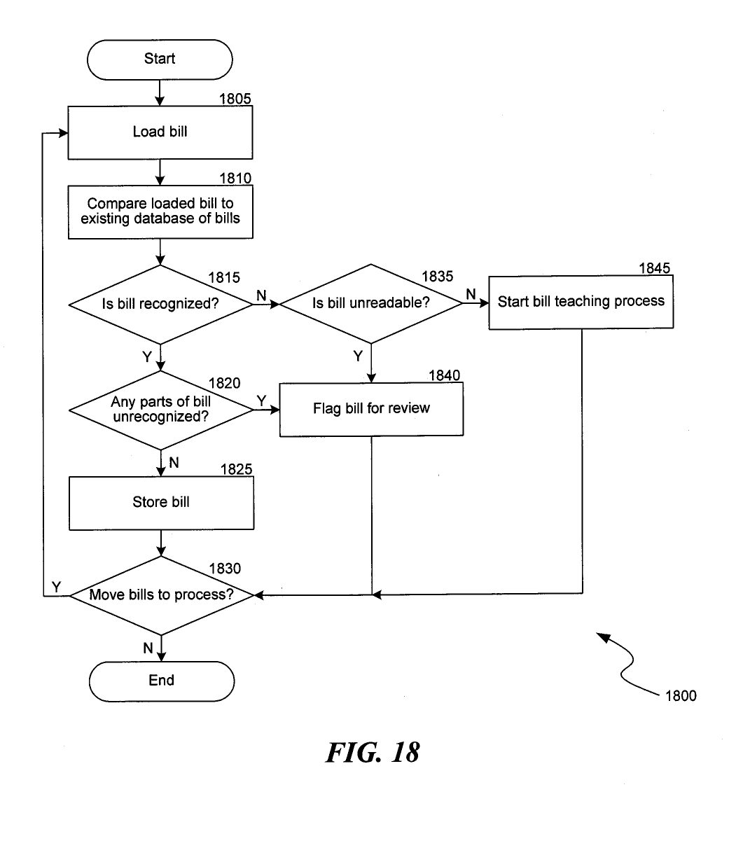

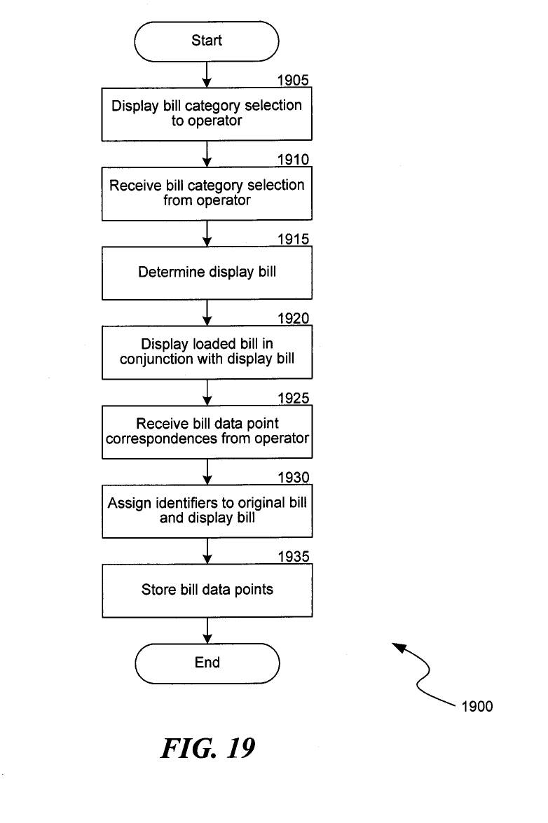

FIG. 18 is a flow diagram of a process 1800 that the system can use for recognizing loaded bills. At step 1805, a bill is loaded into the system as described in the process 1700. The system then compares the loaded bill to an existing database of bills in step 1810. In step 1815, the system determines if the bill is recognized. The system may recognize a bill if it is matched to a similar bill or vendor in the system. If the bill is recognized, the system then determines if there are any parts of the bill that are unrecognized in step 1820. If the bill is unrecognized, the system determines if the bill is unreadable in step 1835. If the bill is unreadable, then it is flagged for future review by an administrator or operator at step 1840, which is also the outcome if any parts of the bill are unrecognized in step 1820. If the bill is readable, then in step 1845 the system starts the bill teaching process, which is described in FIG. 19. In step 1825 the system stores the bill in three databases, one for vendor information, one for client information and one for bill images per client. In step 1830, the system determines if there are more bills to be recognized. If so, the system repeats the process 1800 beginning at step 1805 until there are no more bills to be recognized.

FIG. 19 depicts a process 1900 for teaching the system how to recognize a bill. In step 1905, the system displays a bill category selection to the operator so that the operator can select a category. Categories can include loans, utilities, memberships, subscriptions, services, usage, medical, insurance and others. In step 1910, the system receives a bill category selection from the operator. In step 1915, the system determines a display bill based upon the bill category selection. In step 1920, the system displays the bill to be recognized in conjunction with the display bill to the operator. The operator is then able to create a correspondence with data points from the bill to be recognized with data points from the display bill. In step 1925, the system receives the created data point correspondences from the operator. The system assigns an alphanumeric identifier to the display bill and a similar identifier to the original bill. In some embodiments the alphanumeric identifier is formed by combining identifiers for the vendor, bill category, client and a series code for the bill. In step 1935, the system stores the bill data points. This process enables the system to recognize that future bills that are part of the same series as the original bill are connected to the original bill.

Block 105 System & Method for Address Changes with Vendors

Overview

A subsystem is described below that enables an individual to submit an address change request on their behalf or on behalf of another individual. The subsystem enables the individual to submit the address change request once and the subsystem notifies the appropriate vendors. The subsystem also requests feedback from users on submitted address change requests and updates stored vendor data based upon the feedback.

### DETAILED DESCRIPTION OF SUITABLE EMBODIMENT

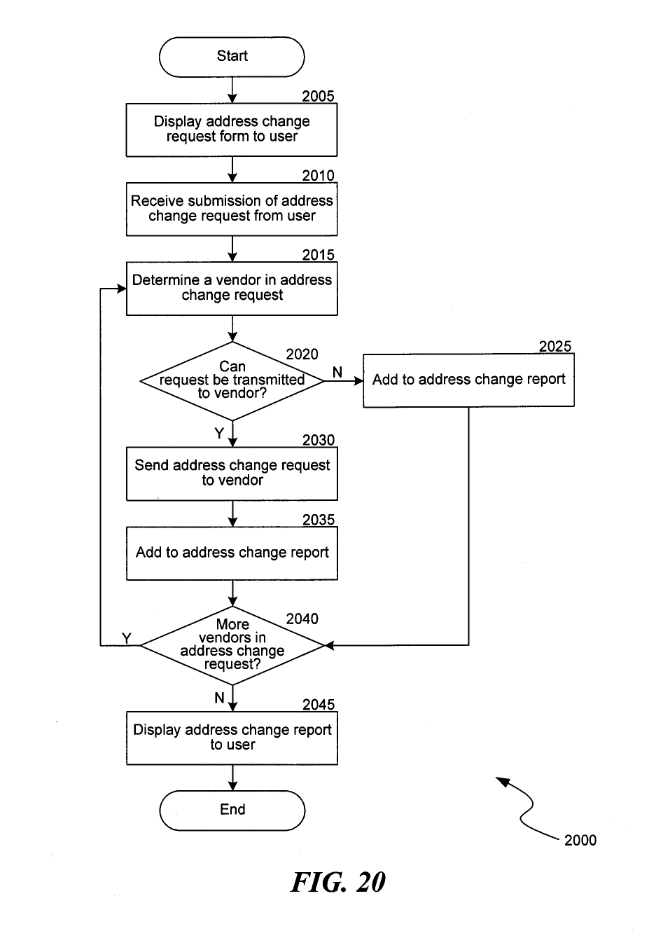

FIG. 20 depicts a process 2000 for enabling a user to submit an address change request on their behalf or on behalf of another user to multiple vendors. In step 2005, the system displays an address change request form to the user. The address change request form can require the user to specify their current and new addresses as well as the vendors with whom the user wishes to change their address. The address change request form can allow the user to attach a letter or other document indicating their approval or allow the user to affix an electronic signature. The address change request form can also allow the user to attach a waiver or release permitting the system to make address changes on the user's behalf. In step 2010, the system receives a submission of the address change request form from the user. In step 2015, the system determines a vendor in the address change request submission for which the user wishes to change their address. The system maintains a vendor database that specifies, for each vendor in the database, how a user can make a change of address request. For example, certain vendors may permit a user to fax or email a change of address request form to the vendor. Other vendors may only accept change of addresses over the telephone. In step 2020, the system checks the vendor database to ascertain if the address change request can be transmitted to the determined vendor. If the request cannot be sent to the vendor, in step 2025, the system adds an indication of an unsuccessful request to an address change report that it prepares for eventual display to the user. If the request can be sent to the vendor, in step 2030, the system transmits the address change request to the vendor and in step 2035, the system adds an indication of a successful transmittal to the address change report. In step 2040, the system checks to see if there are more vendors in the address change request; if there are, the system repeats the process 2000 beginning at step 2015 until there are no more vendors to be sent an address change request. The system then displays the address change report to the user in step 2045. The address change report can inform the user of the status of their address change requests as well as any next steps that the user needs to take in order to finalize their address change request with the selected vendors, such as calling a specific department of the vendor. The system can store for analysis purposes the success rate of address change requests on an individual vendor basis and display that information to the user.

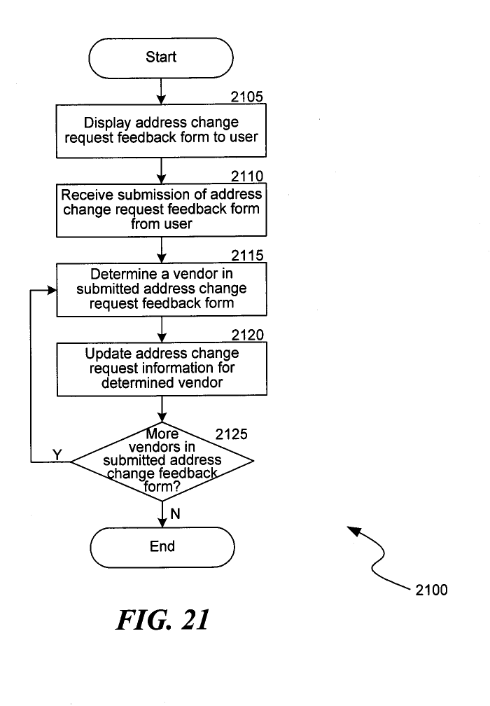

After the user has submitted an address change request, the system can request feedback from the user regarding their request. FIG. 21 depicts a process 2100 for obtaining user feedback regarding an address change request. In step 2105, the system displays an address change request feedback form to the user. The form may query the user as to different aspects of the address change request for each requested vendor, such as whether the request was successful, what additional steps, if any, the user had to take in order to finalize the address change request, and the length of time to complete the request. In step 2110, the system receives the submission of the address change request feedback form from the user. In step 2115, the system determines a vendor in the submitted address change request feedback form, and in step 2120, the system updates address change request information for the determined vendor. In step 2125, the system determines if there are more vendors in the submitted address change request feedback form; if there are, the system repeats the process 2100 beginning at step 2115 until there are no more vendors in the submitted address change request feedback form. This process enables the system to update address change request information for vendors to ensure the success of future address change requests.

### Block 106 System & Method for Rating Vendors

Overview

A subsystem is described below for calculating a vendor rating that is based at least in part on bill pay data. Disputes between an individual and a vendor over a bill or aspects thereof sometimes occur. Such disputes can be documented as described in Block 102 describing the Customer/Client Bill Blog. Based on the documented data, the system can calculate a rating for a dispute between a user and a vendor to create a dispute rating. The system can then aggregate dispute ratings for individual vendors to create a vendor rating.

### DETAILED DESCRIPTION OF SUITABLE EMBODIMENT

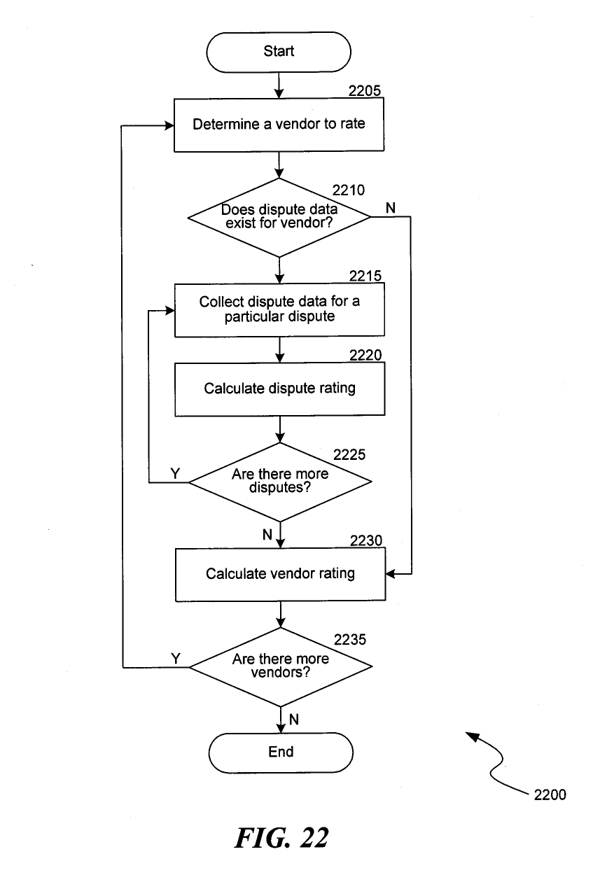

FIG. 22 depicts a process 2200 for calculating a vendor rating. In step 2205, the system determines a vendor for which a vendor rating will be calculated. In step 2210, the system determines whether dispute data exists for the determined vendor. For vendors with no dispute data, factors such as the numbers of bills paid (with no disputes), comparison to competing businesses or similar categories can be taken into account to calculate a rating in step 2230. For vendors for which dispute data exists, in step 2215, the system identifies a particular dispute and collects dispute data for that dispute. The system can collect data such as the length of the dispute, the status of the dispute, the disputed issue, the severity of the dispute, the amount of money at issue in the dispute, user feedback regarding the dispute and the vendor, and other factors. The system can determine the length of the dispute by the start time and the end time as well as any time spent by the user on the dispute. The system can determine the severity of the dispute based upon the number of posts in the bill blog and the status of each post. In step 2220, the system can then determine a rating for the dispute based upon these collected data points. The data points can be averaged, weighted equally or unequally or aggregated in various ways to determine a dispute rating. In step 2225, the system determines if there are more disputes to rate for the determined vendor; and if there are, the system continues the process 2200 at step 2215 until there are no more disputes to be rated. In step 2230, the system calculates a rating for the determined vendor. In some embodiments, the system averages the dispute ratings to calculate a vendor rating. The system can also calculate the vendor rating based upon other vendor history, and the history can be narrowed to a specific time period to enable the determination of vendor ratings for a specific time period. In step 2235, the system determines if there are more vendors to rate; and if there are, the system continues the process 2200 at step 2205 until there are no more vendors to be rated. The system can perform the vendor rating process periodically to determine vendor ratings or the vendor rating process can be performed for a specific vendor upon the receipt of new dispute or vendor data, such as a new post in a bill blog.

### Block 108 Automated Ledger Subsystem

Overview

For a user managing their expenses, the amount of management required can be extensive. A user can have multiple accounts, dozens of bills that must be entered and managed, and hundreds of individual transactions within a given period of time. A user can also have unique categories that they use as well as unique expense sources that are difficult and sometimes change in how they must be categorized. Described below is a subsystem that creates an individual expense accounting ledger for a user of a bill pay system. An individual expense accounting ledger can minimize the number of transactions that need to be manually entered and can minimize the amount of manual categorization required for transactions.

### DETAILED DESCRIPTION OF SUITABLE EMBODIMENT

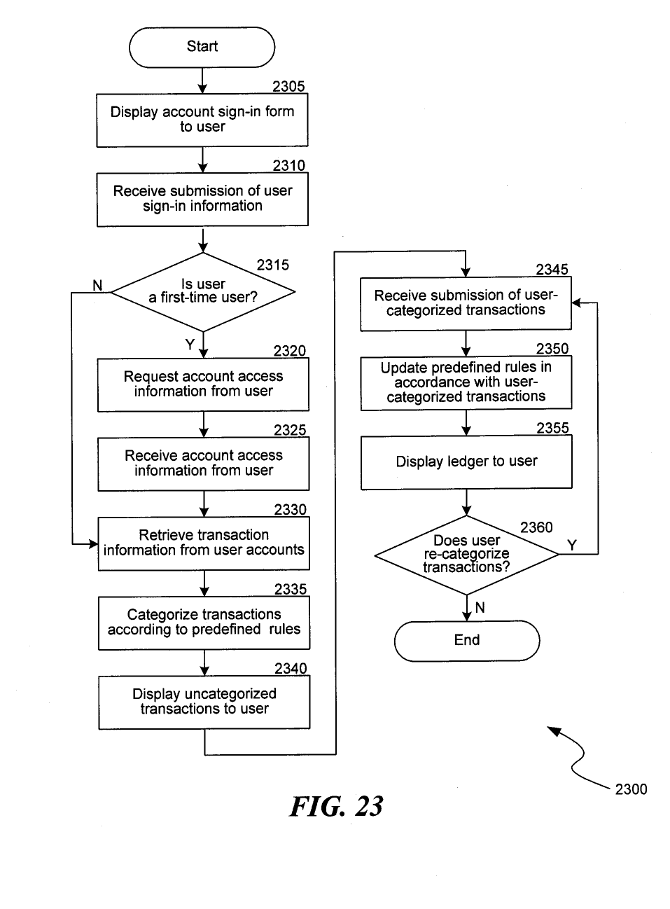

FIG. 23 depicts a process 2300 for creating an individual expense accounting ledger for a user of a bill pay system. In step 2305, the system displays an account sign-in form to the user. In step 2310, the system receives a submission of the user's sign-in information. In step 2315, the system determines whether the user is a first-time user of the bill pay system. If the user is a first-time user, then the system in step 2320 requests account access information from the user, which can include account numbers or account logins, passwords and other personal identification. If the user is not a first-time user, then the system retrieves transaction information from the user's accounts as described in step 2330 below. Having a user's account access information enables the system to retrieve transaction information from the user's accounts. A user's accounts can include bank accounts, credit card accounts, loan accounts, asset accounts, or other types of accounts held at financial institutions or other custodians. In step 2325, the system receives account access information from the user and in step 2330 the system retrieves transaction information from the user's accounts. In some embodiments the system uses a third-party data aggregator to retrieve transaction information from the user's accounts. In step 2335, the system categorizes transactions according to pre-defined rules. In some embodiments the system has three rule templates: a master ledger template, a global ledger template, and an individual ledger template. The master ledger template contains rules to be applied based upon the description in the ledger entry. For example, a rule in the master ledger template would categorize a transaction containing the entry description “University Bookstore” as “Education.” The global ledger template contains rules regarding common categorization requests by users. For example, if the system could not categorize a transaction containing the description “University Pizza” according to rules in the master ledger template, the system can determine what the most common categorization is for “University Pizza”. If there are 10 entries and the most common categorization is “Dining Out” then the transaction is categorized accordingly. The individual ledger template contains rules set by the user. For example, if a user changes the categorization of a transaction containing the description “University Pizza” from “Dining Out” to “Business Expense,” the system will save that as a rule in the individual ledger template. So, the next time that a transaction containing the description “University Pizza” comes through the system, the transaction will be categorized as “Business Expense” unless the user requests otherwise. The individual ledger template can also contain rules such as, for example, that all transactions from a certain account are to be categorized as “Business Expense” or that all purchases from a certain retailer are to be categorized as “Home Repair.” If the user is a first-time user of the bill pay system then the system will apply first the rules of the master ledger template and then the rules of the global ledger template to categorize the user's transactions. If the user is not a first-time user, then the system will apply first the rules of the individual ledger template, if any, and then the rules of the global ledger template and then the rules of the master ledger template. If in either the global ledger template or the individual ledger template there is an equal number of different categorizations for transactions with a particular entry description, such as “University Pizza” being categorized once as “Dining Out” and once as “Business Expense” then the system can apply a rule from either the master ledger template or the global ledger template, respectively.

In step 2340, the system displays uncategorized transactions to the user to enable the user to categorize the transactions as the user sees fit. In step 2345, the system receives a submission of user-categorized transactions. In step 2350, the system updates pre-defined rules in the individual ledger template in accordance with the categories assigned by the user to the transactions. In step 2355, the system displays the individual expense accounting ledger to the user. The individual expense accounting ledger also enables the user to re-categorize transactions if the user wishes. In step 2360, the system checks to see if the user has re-categorizes any transactions; if so, the system continues the process 2300 at step 2345 until the user no longer re-categorizes any transactions. The system can perform steps in the process 2300 periodically or upon user request. For example, the system can retrieve transaction information from user accounts when the user is not signed in to the system so as to minimize potential wait time for the user.

### Block 109 Automatic Payment, Approval, Recognition and Execution Subsystem

Overview

When a third party manages the payment of bills for an individual, or a large group of individuals, automating certain aspects of the bill-paying process allows for improved efficiency, security and customer service. This subsystem manages the basic bill review and makes recommendations to either approve or more deeply review the bill. This allows an operator to focus on bills that require more service while still managing a high number of clients. The subsystem operates utilizing a basic set of preloaded preferences based on the type of bill, client, operator, vendor type and rating and other requirements. The subsystem is also designed to learn from past experiences and improve.

### DETAILED DESCRIPTION OF A SUITABLE EMBODIMENT

In a system designed to manage bill payment for an individual or group of individuals by a third party, the payment of individual bills can be made easier by developing a process for automating payment approval. The data will enter the system after being processed from an OCR system designed to extract the pertinent data from the bill and auto-populate within the system, or can be entered manually, e.g., hard-to-read data that is clarified over the phone, hand-written notes, etc. This system can review bills as they are processed into the program to determine if they meet a set pattern of criteria and then make a recommendation to pay or to place under further review. Criteria for making the recommendation include analyzing a database of previous payments made to that particular vendor for the corresponding individual in the past. Other criteria may be dictated by the administrator over the individual account and the operator manages. These criteria fall into categories such as fraud detection, error detection, whether the bill fails to meet any other pre-described criteria, etc. This system will increase time needed to pay bills for another individual and increase the efficiency of the process while at the same time improving quality control, security and fraud protection.

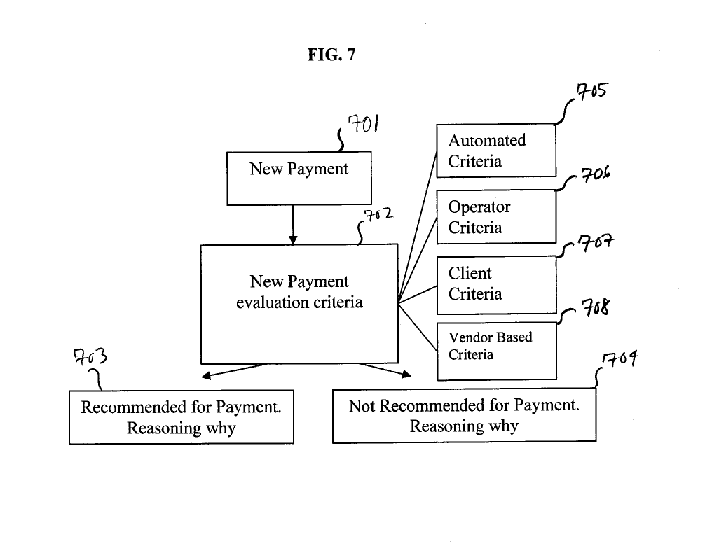

In a system designed to manage the payment of bills for an individual or group of individuals by a third party, the system reviews all upcoming or new payments 701 before they are submitted to hold them against a preset list of criteria 702, as shown in FIG. 7. These criteria can be based on the system administrators' requirements 706 and can be based on current and historical data, vendor ratings and type, client preferences and operator parameters. These criteria can also be based on automated criteria 705, client-defined criteria 707, and vendor-based criteria 708. Each bill that is placed in the system is assigned a list of criteria 702. Within the system, the operator can see a list for an individual or of a collection of client bills and the system will display those that meet criteria for payment 703 and those that do not 704. Associated with this system will be the equation structure for determining what a payable bill is and what is not.

### Block 110 Connecting a Third-Party Managed Bill Pay System to a Client Bank or Several Banks

Overview

When managing the payment of bills for an individual or group of individuals, in order to improve automation, security, and oversight of the process, one should be able to interact with any banking institution to transfer funds from the clients account to the vendor being paid. A single operator should be able to pay bills for multiple clients from a multitude of banking institutions. As described below, a subsystem connects with any banking institution, and allows the client to link into the system from their bank.

This subsystem is designed to service those individuals looking for a managed service by a third party dedicated to managing the payment of their bills. In order to help automate this process, a connection to the individual client's bank account is created. This allows the subsystem to manage the process while maintaining a high degree of security and automation.

### DETAILED DESCRIPTION OF A SUITABLE EMBODIMENT

This subsystem manages the payment of bills for a group of individuals by a third party. To allow for flexibility for the end client, the system used to manage the payment of bills makes an electronic connection with each individual client's bank of choice. This connection occurs through a secure electronic channel allowing for the transfer of funds from the clients designated bank account to the vendor selected using the third-party management system. Within the third-party management system, a user profile page allows the operator to enter in as part of standard client profile information 805, data pertaining to the financial institution that the client chooses. The partner bank makes available to the system data pertaining to the client's account such as the account balance and activity reports. This information is loaded on the management system and accounted for to reflect history from not only the bank but also from changes in the management system. For the client, this system can have the look and feel of the bank they hold the account with but for the operator is a standardized platform.

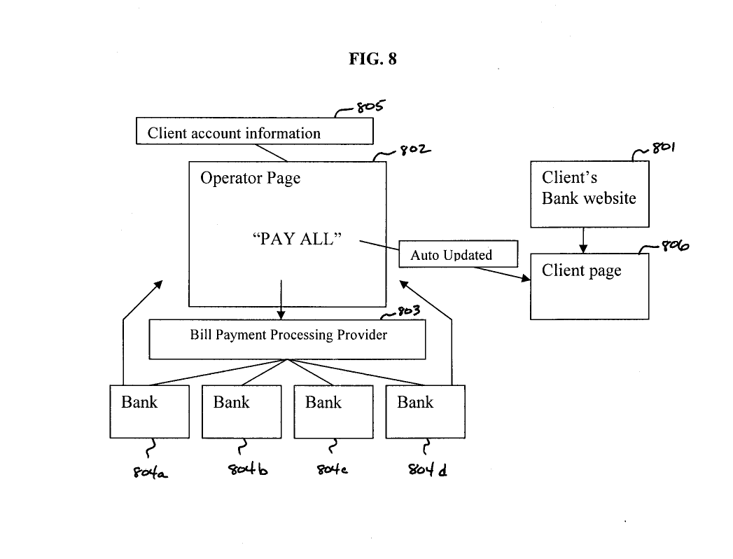

Referring to FIG. 8, the diagram depicted on the right shows that the client can access this system through their bank's website 801 or through a client page 806. The flowchart shown to the left represents interaction between management software, the banks and how the vendors receive payment. The operator of the system uses client account information 805 to submit a group of client's bills for payment on an operator page 802. With each request the system automatically attaches an account number, client data and vendor data needed to make this payment. A bill payment processor 803 alerts the banks 804 (shown individually as banks 804a-d) and attaches payment information. The banks notify the system that this payment has occurred, an auto update that the bill has been paid is sent to the client database. On a regular basis, the banks make available to the system available balances and up to date activity. The system may employ an online accessible software routine managed through a central database to perform the above functions.

### Block 111 Payable Bill Algorithm

Overview

In a system where bills are managed and paid by a third party on behalf of an individual, that third party should make the decision of when to pay the bill. In other words, a system designed to manage the payment of bills for an individual by a third party should have a system that makes recommendations on payment approval to the operator.

The subsystem described below relies on a process designed to determine whether the bill should be paid or reviewed further by the operator. This process is designed to take into account many different features of the bill, the profile of the client, operator, vendor type & internal vendor rating, and many separate features. The decision to pay a bill is generally based on a number of factors that the third party should take into account in order to approve the bill for payment. In order to make sure that each payment is screened before paid and that all applicable issues are taken into account, an automated system described below holds the payment up against these parameters first and then makes a recommendation.

### DETAILED DESCRIPTION OF SUITABLE EMBODIMENT

In a system designed to manage the payment of bills for an individual or group of individuals by a third party, a subsystem reviews all upcoming payments before they are submitted to hold them against a preset list of criteria. These criteria can be based on the system administrators' preset requirements, based on current and historical data, vendor rating & type, based on client preferences and operator parameters, current bank balance, etc. Each bill that is placed in the system is assigned a list of criteria. Within the system, the operator can see a list of individual or of a collection of client bills and the system displays those that meet criteria for payment and those that do not. With each bill is an explanation of why the bill is recommended to be paid or why it is not. To determine these criteria, a set formula is created for each bill that takes into account some automated criteria such as payment history, range of variation in amount paid, when the payment was last made and with what frequency, etc. Some other criteria can be defined by the system operator such as client preferences to always review first or review when over a certain threshold, to review further if the bill increases by a certain amount over a period of time, if this is a new bill and that all new bills should be reviewed for a certain period of time, if there is a pending dispute with this bill started either by the client or operator, etc.

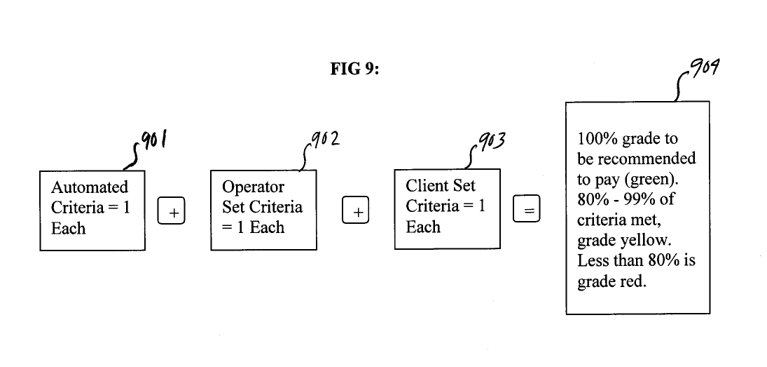

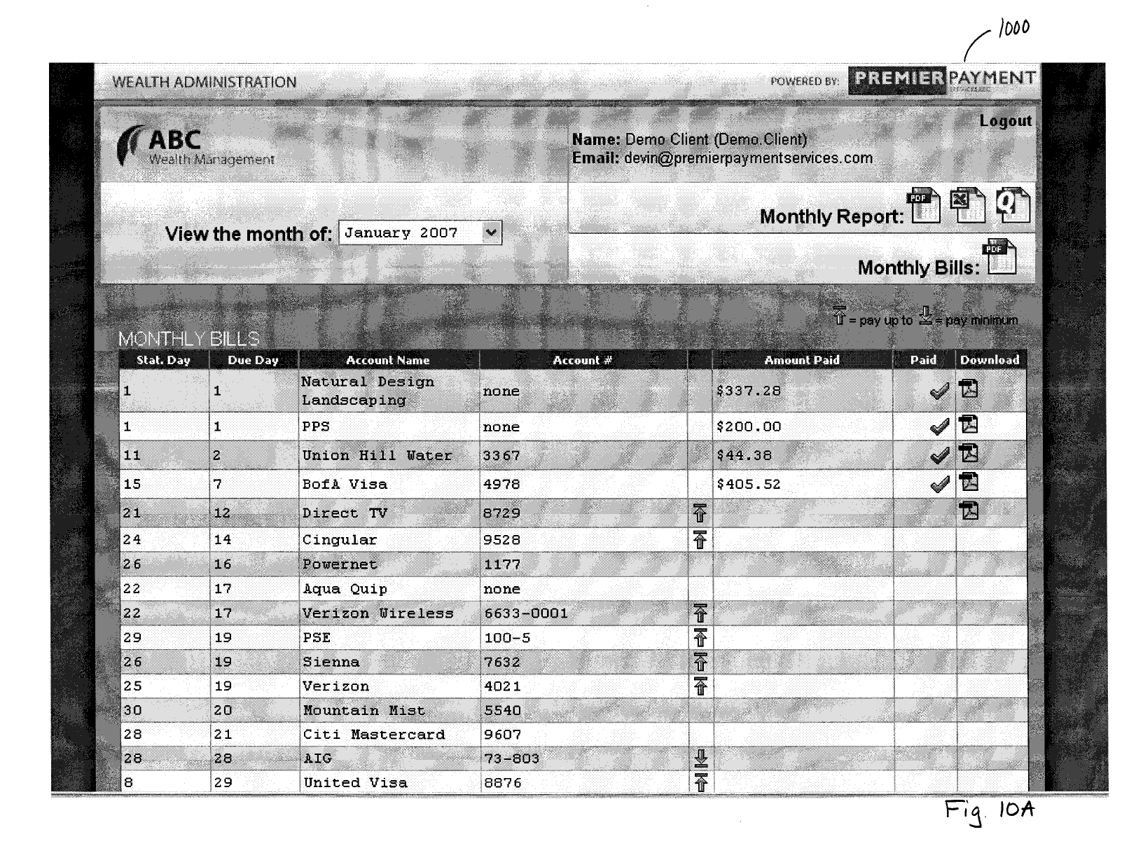

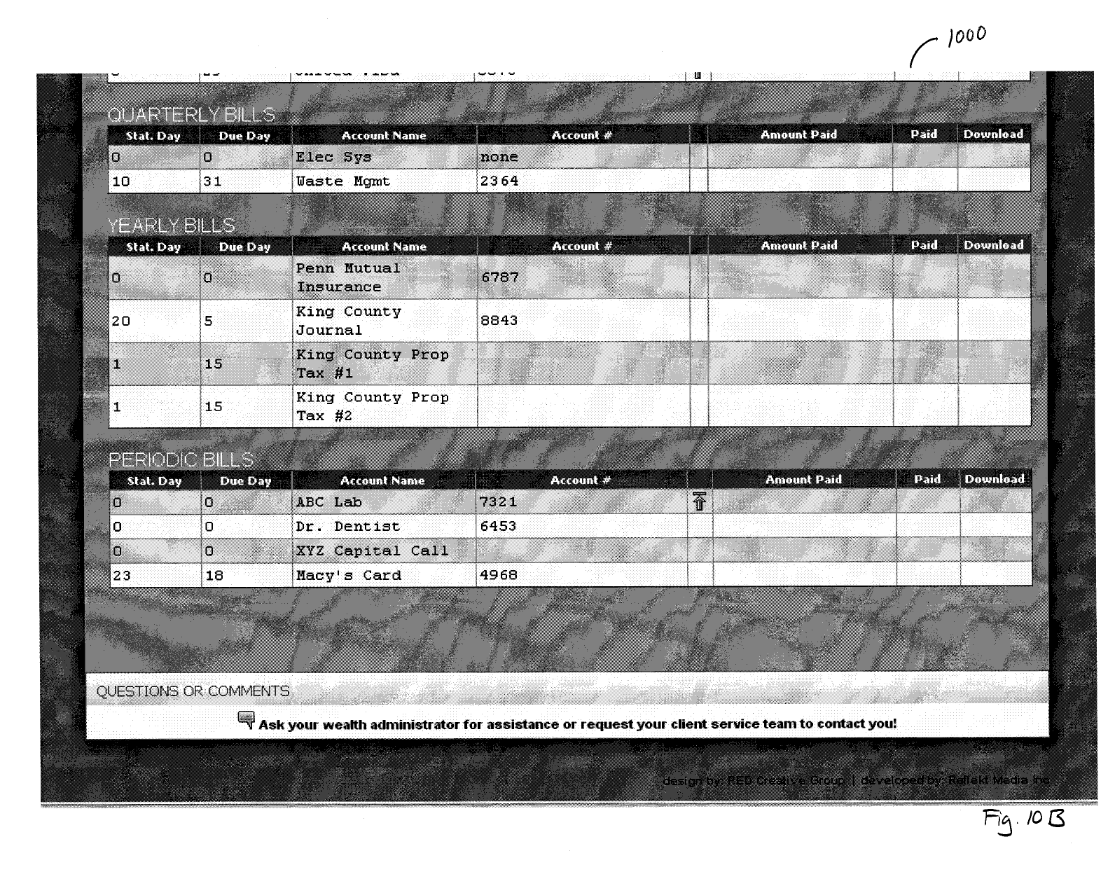

An example of the above routine is shown in FIG. 9. Automated criteria 901 include at least one criterion automatically reviewed by the system and built into the routine to be run on every bill. Some of the desired criteria of this category are as follows: 1) there is a bill attached to the payment request; 2) this is not a new payment, there is historical data on it; 3) this is not a new vendor, there is history on this vendor in the system; 4) the payment information, client information or payment information has not been changed since the previous payment; and 5) outstanding dispute associated with this client/vendor pair.

Operator-set criteria 902 includes criteria set by the operator. The system may provide a list of criteria that the operator can choose from. Whichever are selected are those that are included in the routine. Some examples are as follows: 1) amount to be paid cannot increase by more than (select an amount, e.g., 10%) per period; 2) always needs further review, never allow for auto approval; 3) flag for administrator review if the account number being paid does not match the account number on the bill; 4) flag for administrator review if the payment is to an individual and not a company; and 5) flag for administrator review if this is a one time high dollar (select from amount variations) payment that has no similar history (for example: operator requests to pay a vendor $500 that is normally $50 per month).

Client-set criteria 903: This criterion is requested by the client through the client portal or by the operator on the clients' behalf. Whichever are selected are those that are included in the routine. Some examples are as follows: 1) client approval required before payment; 2) do not pay if amount is over a certain amount; 3) pay minimum required unless notified otherwise; 4) always pay full balance no matter amount; and 5) alert if amount increases by (select percentage change and frequency).

When the payments have been run through the payable bill routine of FIG. 9, they are judged by the percentage of criterion that they cleared 904. To receive a green rating, the payment should meet 100% of criteria. Only bills that receive a green rating receive a recommendation that they be paid. To meet a yellow rating, the payment should pass 80%-99% of criteria. Any payment meeting under 80% of selected criteria is listed as a red rating. The system employs a managed database of records and disputes. This system will allow the client to access the files via a secure internet connection while the operator will use a similar connection method.

### Block 112 Data Mining and Reporting System

Overview

A bill payment system collects a variety of data regarding users of the system, their bills, and various vendors. This data can be aggregated and mined to produce custom reports that could provide useful information. Described below is a subsystem that enables data mining and reporting on data contained within a bill payment system.

### DETAILED DESCRIPTION OF SUITABLE EMBODIMENT

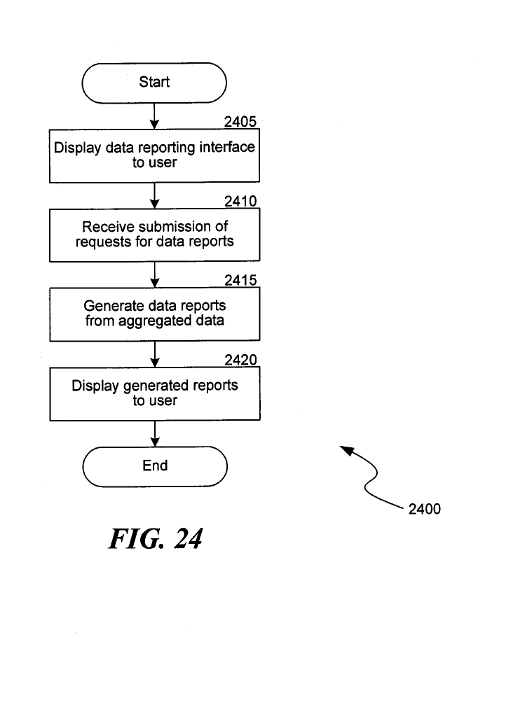

FIG. 24 depicts a process 2400 for producing reports on bill payment data. In step 2405, the system displays a data reporting interface to a user. The data reporting interface can contain a variety of pre-defined reports that the user can select. Such pre-defined reports can include: the average amount of a bill in a particular category, such as utilities, the average amount billed for a particular vendor, the total amount billed to a particular user, or any other report based on various factors. The data reporting interface can also enable the user to specify custom reports to be run based on user-specified factors. In step 2410, the system receives a submission of a request for a report. In step 2415, the system generates a report based on aggregated data and the appropriate privilege level for the user. The reporting system can allow different levels of access to different reports based upon user privileges. For example, a system administrator may have access to all system data and thus be able to view any report. A system operator may only have access to reports for the clients for whom system operator is managing bills as well as to aggregate reports on all the clients for whom the system operator is managing bills. A user may only have access to reports based upon their individual bill payment data as well as to aggregate reports on individuals that have personal identifying information removed, so as to enable the user to make comparisons with other users of the bill payment system. For example, a user may have access to a report that specifies the average individual monthly cell phone bill amount, but would not have access to data specifying actual cell phone bill amounts for other users of the bill payment system. In step 2420 the system displays the generated report to the user.

PPS 115 Auditing Engine to Operate within a Concierge Bill Pay System

Overview

In a bill paying system designed to oversee the management of paying bills for a group of individuals by a third party, the need arises for having an auditing system that will allow the administrator to maintain a high level of security and automation of risk reduction in the system. Such concerns arise such as whether the operator is correctly paying a bill, is transferring the correct amount, is defrauding a client in some way or is inaccurately entering data that must be accounted for and a system to constantly audit activity is paramount.

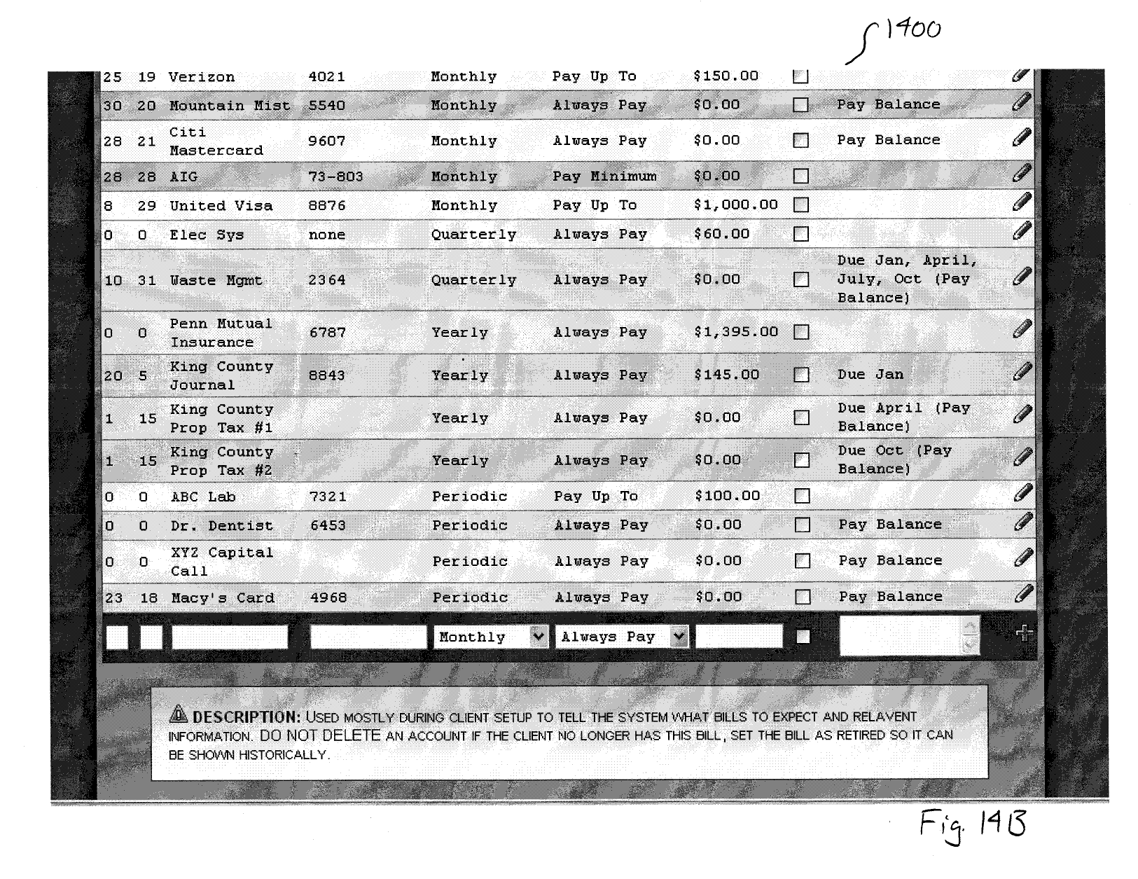

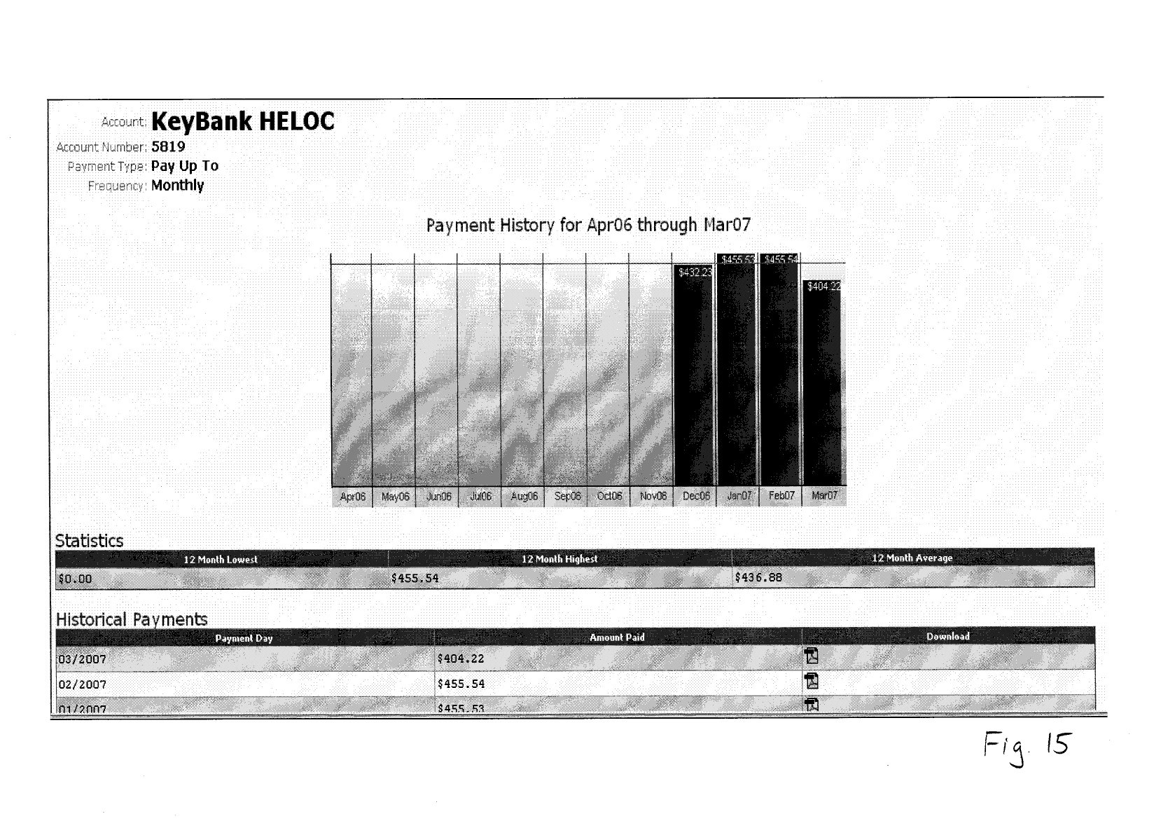

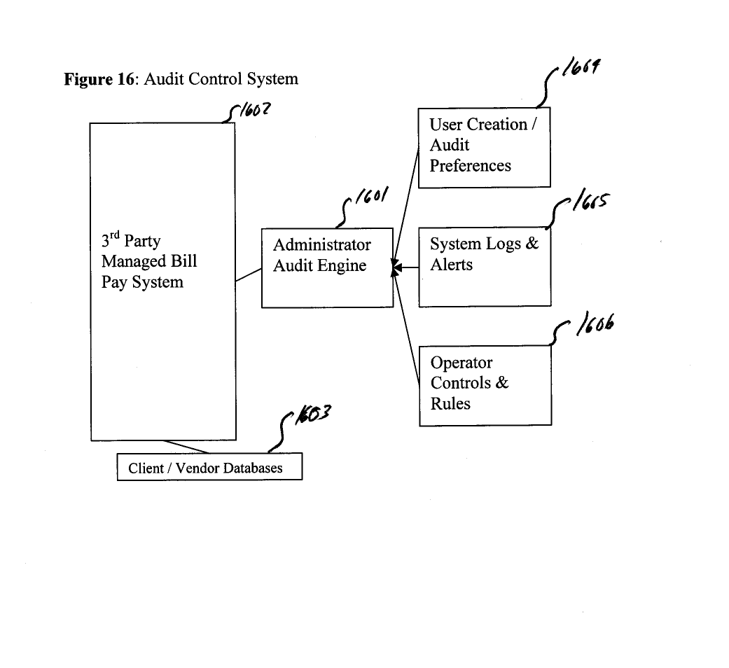

As shown in FIG. 16, the bill paying system may include an auditing subsystem that permits rules, threshold, flags, etc. to be set within the main system. Further the subsystem may include functions to permit the bill paying system to review the user profiles and to review data in the system databases, and compare that against current requests.

The auditing subsystem employs a set of databases 1603 that manage the historical client and vendor information. Also, an administrator function 1601 creates or facilitates creating rules, making of approvals, and setting of levels of sensitivity in the system on what will raise an ‘alarm’. The databases 1603 collect data such as average vendor payments, average client payment, client preferences, variation in payment history, and payment thresholds that may alert the administrator, as well as other such data points. This bill paying system 1602 recommends whether a bill is payable and if not why. The bill paying system 1602 also has a database that collects and stores all security and fraud concerns in the bill paying system 1602. The administrator will be able to review the bill paying system 1602 by operator and client for historical data and points of interest

### DETAILED DESCRIPTION OF SUITABLE EMBODIMENT

The auditing subsystem may include the following components.

1. Creation and Management of Users 1604: the auditing subsystem may include a page which permits the administrator to create new users (operators, advisor and clients) as well as set preferences for auditing the system.

2. System Logs and Alerts 1605: The auditing subsystem automatically logs all usage of the system and by who based on preset criteria. This data can be searched by client, operator, date or by activity. Alarms or notifications can be set for specific activity depending on a sensitivity level set by the administrator. These will show up in separate reports or are “flagged” for review when the administrator logs onto the bill paying system. For example, all bills that the system recommends for further review can be flagged for the administrator to see.

3. Operator Controls and Rules 1606: the auditing subsystem may include a page that contains rules set by the administrator for specific operators and/or operators' assigned clients. If specific criteria are not met while the operator is using the system, the operator cannot proceed without a supervisor's approval. General rules can be set for all operators or specific limitations can be set for each operator and/or client. Examples of such rules include the following: 1) All account numbers entered are matched against those on the bill before payment is made. Any discrepancies to this rule will lock out the operator from paying the bill and it will be recorded here in a log. A supervisor's approval code must be entered to override the rule and pay the bill; 2) Any payment request over a certain amount will need a supervisor's approval code to be paid; 3) All new vendors added to the system must be approved before payments can be made. Bills cannot be paid to these vendors until the administrator approves the vendors.

The administrator has the ability to create accounts for managers that can only view system-wide information set by the administrator. This allows multiple users to audit the system from different angles with different information. One manager may be notified when then system finds a new vendor that needs approval. Another manager may be notified of all bills above a certain dollar limit.

Overall, see FIG. 16 which shows an example of an auditing subsystem that includes a set of databases as well as a software program that allows the system administrator to review, approve, and record points of interest. The administrator is also be able to manage the settings and rules in the system

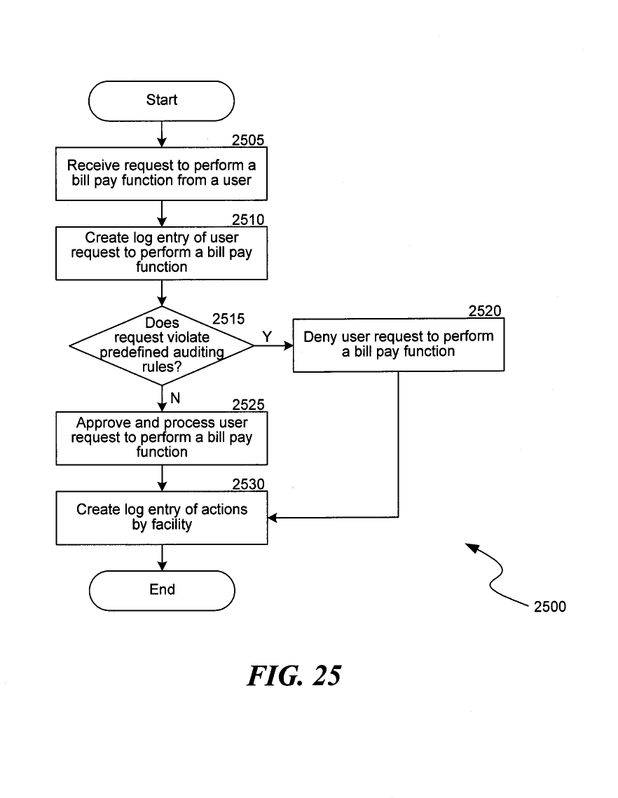

FIG. 25 depicts an auditing process 2500 of a bill payment system. The process can begin at step 2505 when the system receives a request from a user to perform a bill payment function. In step 2510, the system creates a log entry of the user's request to perform a bill payment function. In step 2515, the system determines if the user's request violates any rules, such as those defined above. If a rule is violated, the system denies the user's request to perform a bill payment function in step 2520 and the proceeds to step 2530. If no rules are violated, the system approves and processes the user's request to perform a bill payment function in step 2525. In step 2530, the system creates a log entry of actions by the facility, which includes approvals, denials, and actions subsequent to approvals and denials.

### Block 116 Transaction Tracking System

Overview

A user of a bill payment system may wish to be notified when a certain charge or transaction has posted to one or more of the user's account. For example, if a user visits a commercial entity such as a restaurant and uses their credit card, sometimes during this type of transaction the card may be swiped multiple times in error by the cashier. The user may worry that they may be double-charged. Or, a user may visit a commercial retail store and return a product to receive a refund. The user may wish to be notified when the refund has been processed to their account.

A bill payment system can include a subsystem that enables users to track or locate individual charges on their accounts or vendor statements. Described below is a subsystem that enables users to track or locate individual charges on their accounts or vendor statements.

### DETAILED DESCRIPTION OF SUITABLE EMBODIMENT

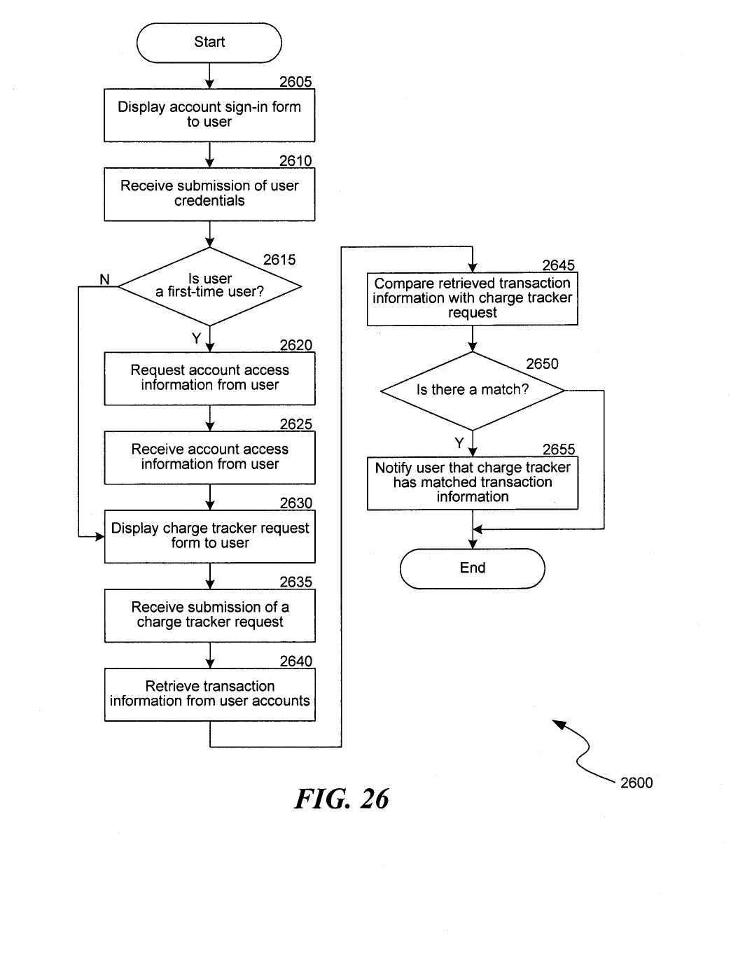

FIG. 26 depicts a process 2600 for enabling a user to track or locate individual charges on their accounts or vendor statements. In step 2605, the system displays an account sign-in form to the user. In step 2610, the system receives a submission of user sign-in information. In step 2615, the system determines whether the user is a first-time user of the bill pay system. If the user is a first-time user, then the system in step 2620 requests account access information from the user, which can include account numbers or account logins, passwords and other personal identification. If the user is not a first-time user, the system proceeds to step 2630. In step 2625, the system receives account access information from the user. In step 2630, the system displays a charge tracker request form to the user. In step 2635, the system receives a submission of a charge tracker request. In step 2640, the system retrieves transaction information using the user's account access information. In step 2645, the system compares retrieve transaction information with the charge tracker request. In step 2650, the system determines if there is a match between the retrieved transaction information and the charge tracker request. If there is a match, the system notifies the user in step 2655 that the requested charge tracker has matched transaction information. The system can notify the user via methods set by the user, such as by calling, emailing, faxing, posting on a website, or otherwise notifying the user.

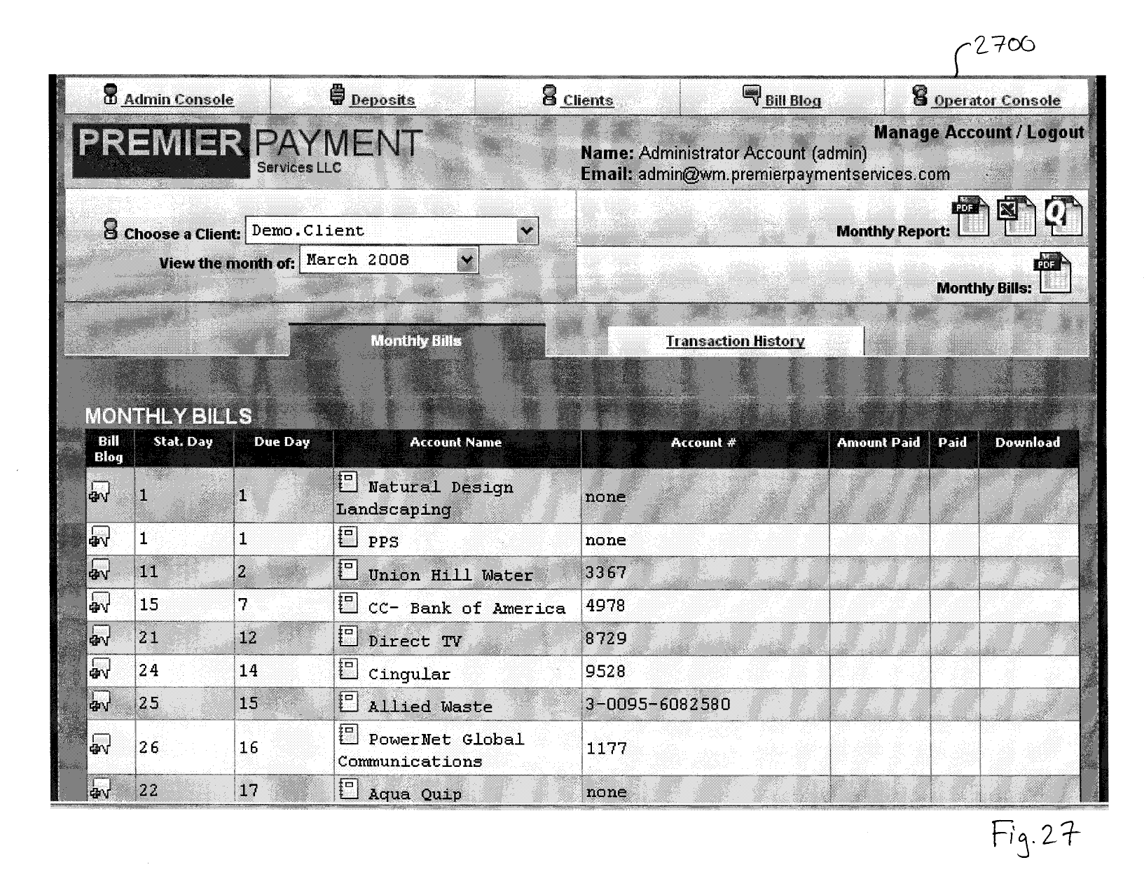

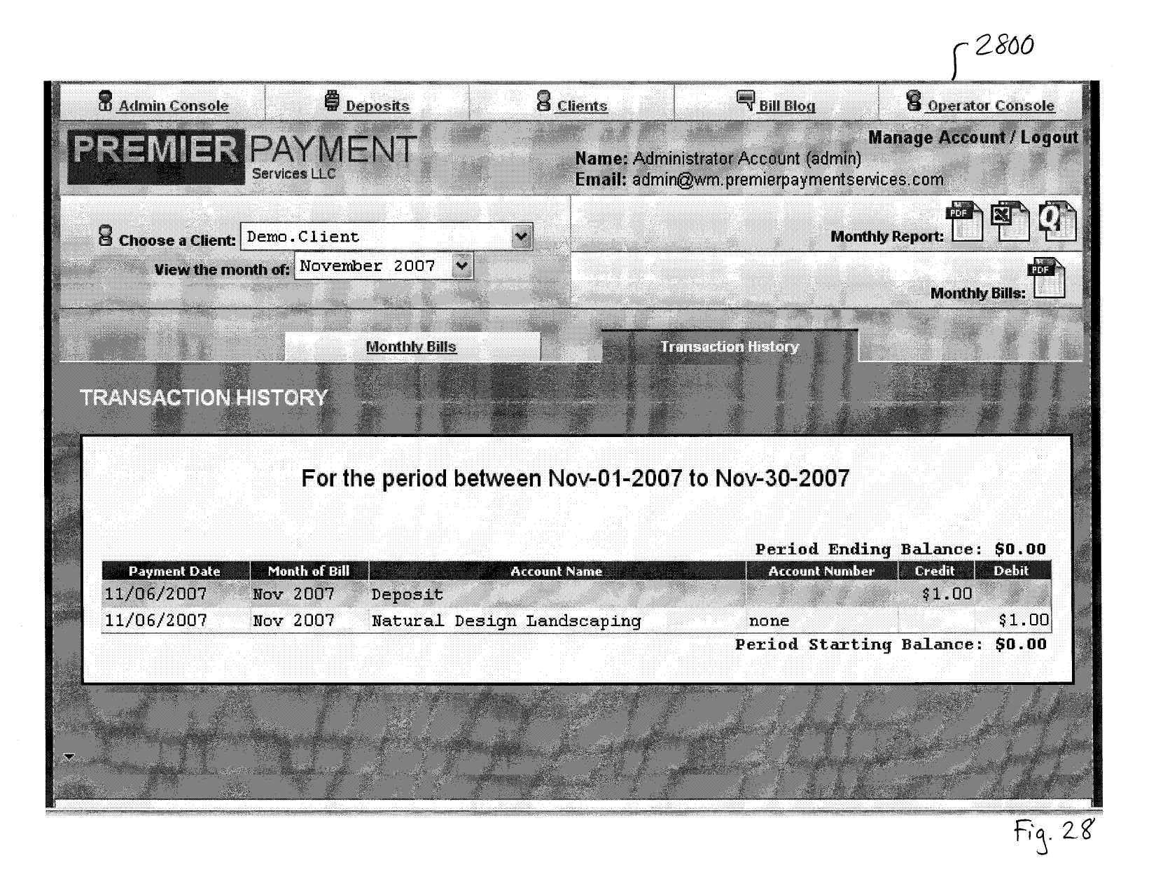

FIGS. 27 through 35 are screen shots showing additional examples of display descriptions or web pages that the system may provide. FIG. 27 depicts a web page 2700 that the system may provide to a client when the client first accesses the system. The web page 2700 displays bills for the current month, the bills that were paid, and the amount paid. The web page 2700 includes links that enable a client to view digital copies of a bill, view the history of bills for a particular vendor, view bill reporting information, interact with the client's bookkeeper, view and manage various aspects of the client's account and perform other functions. FIG. 28 depicts a web page 2800 that provides information on transactions in a client's account that occur during a particular period of time. The client can view debits and credits of funds for that particular period. The web page 2800 can also display information on the client's associated bank accounts, such as the name of the bank holding the account, the bank routing number, and the account number. The web page 2800 can also display information on whether or not a bill should be payable based on the results of the payable bill algorithm.

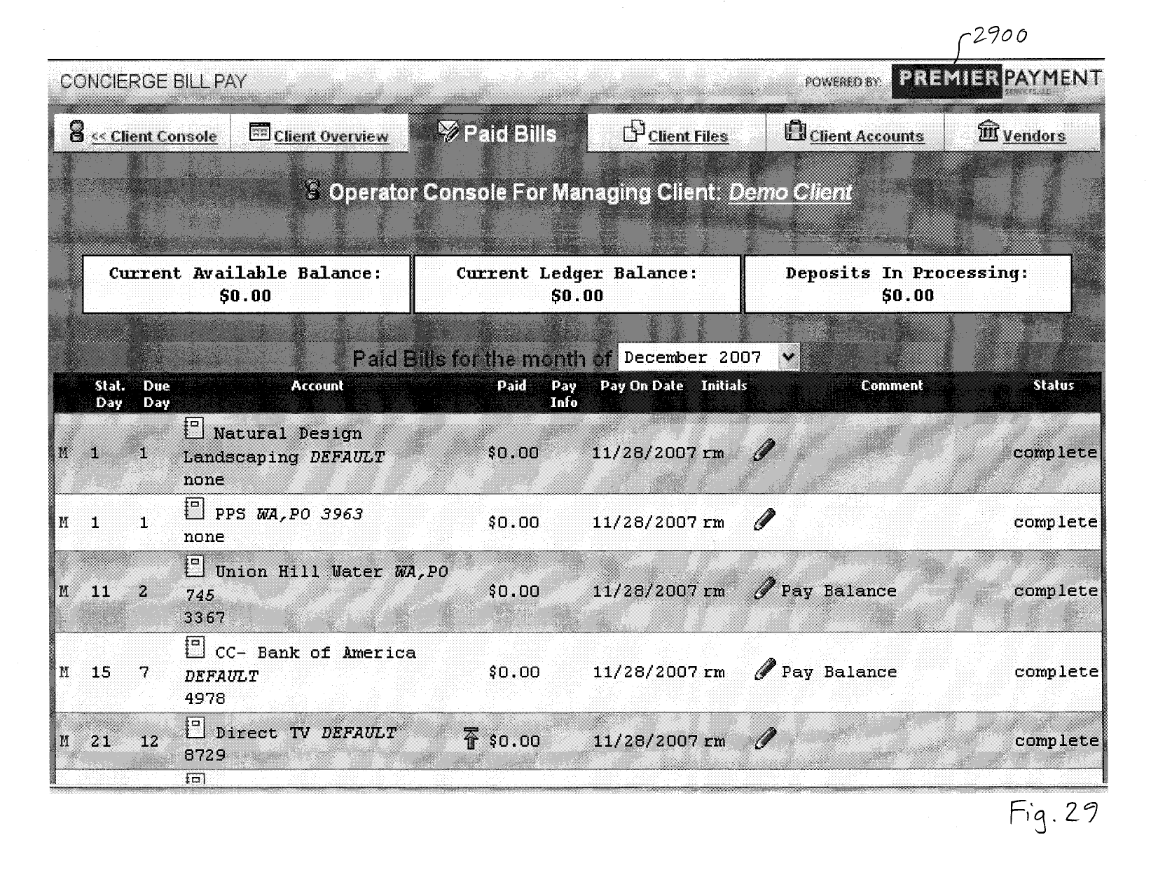

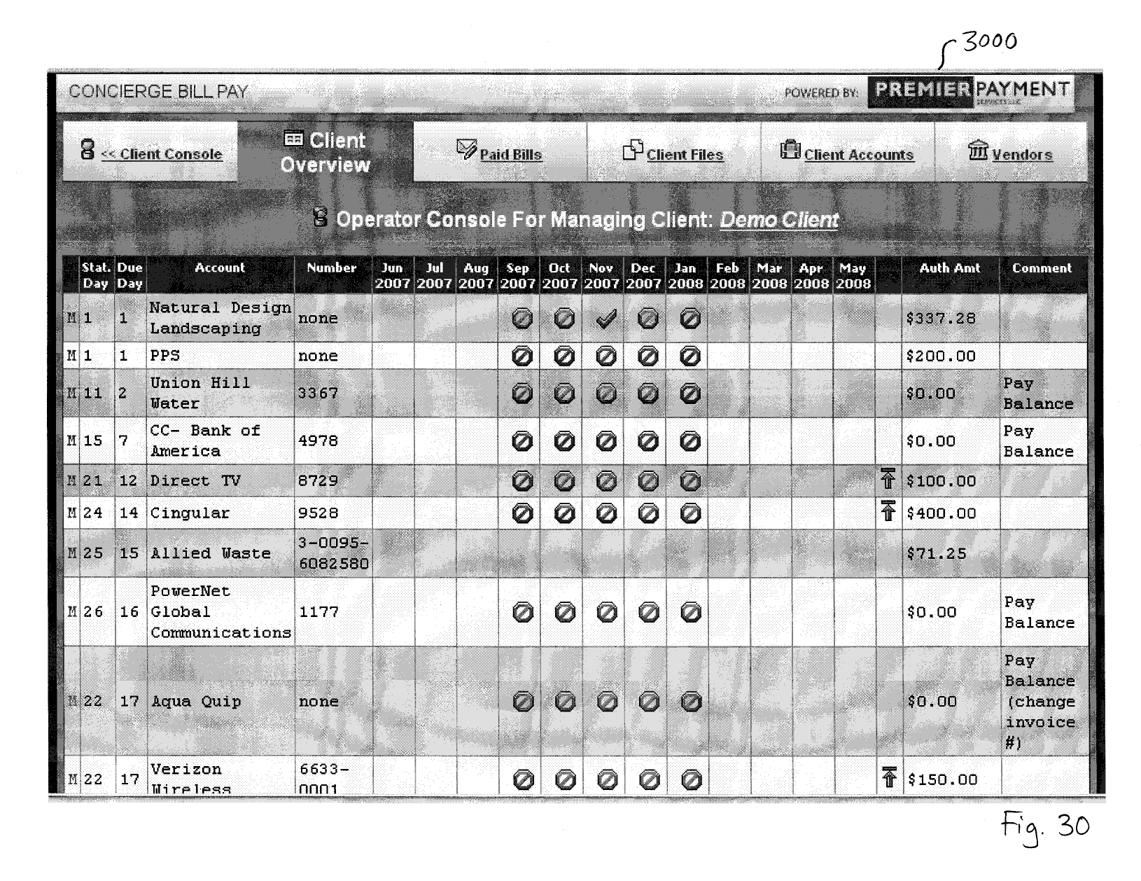

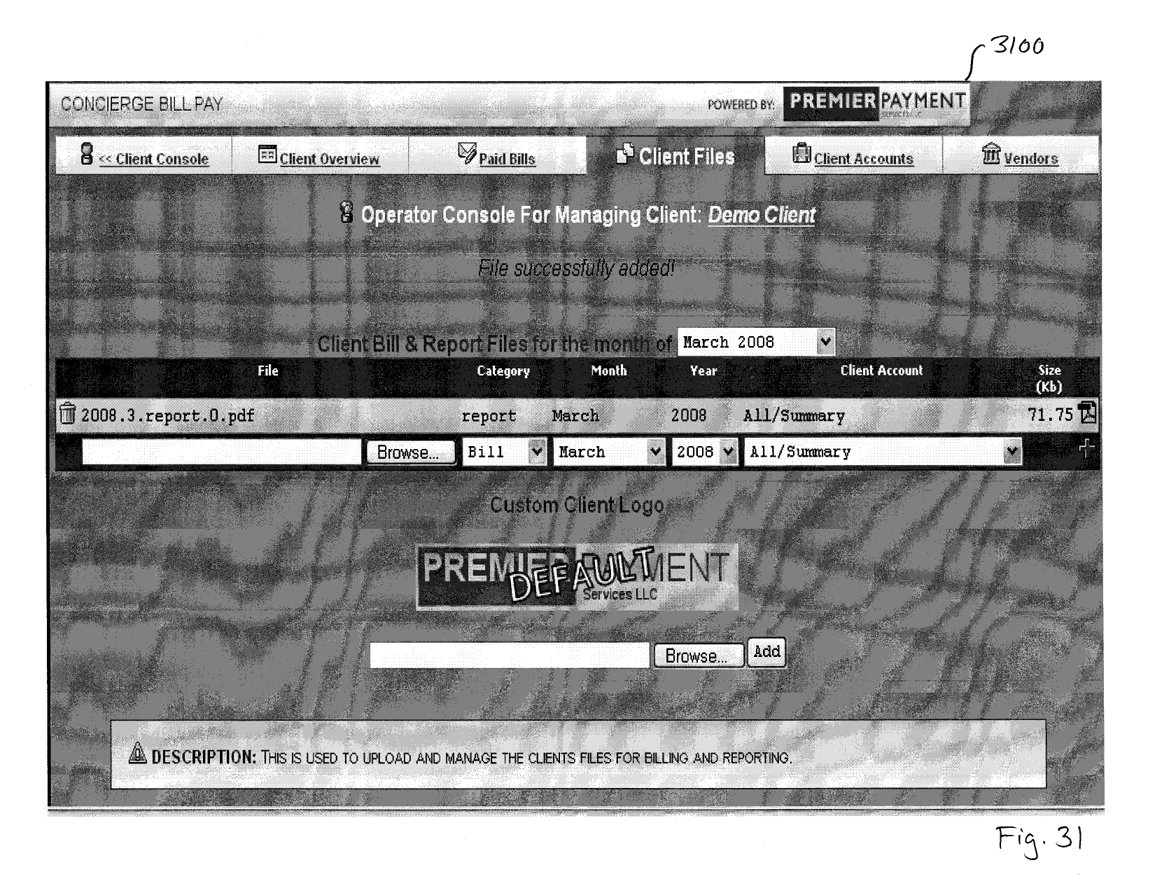

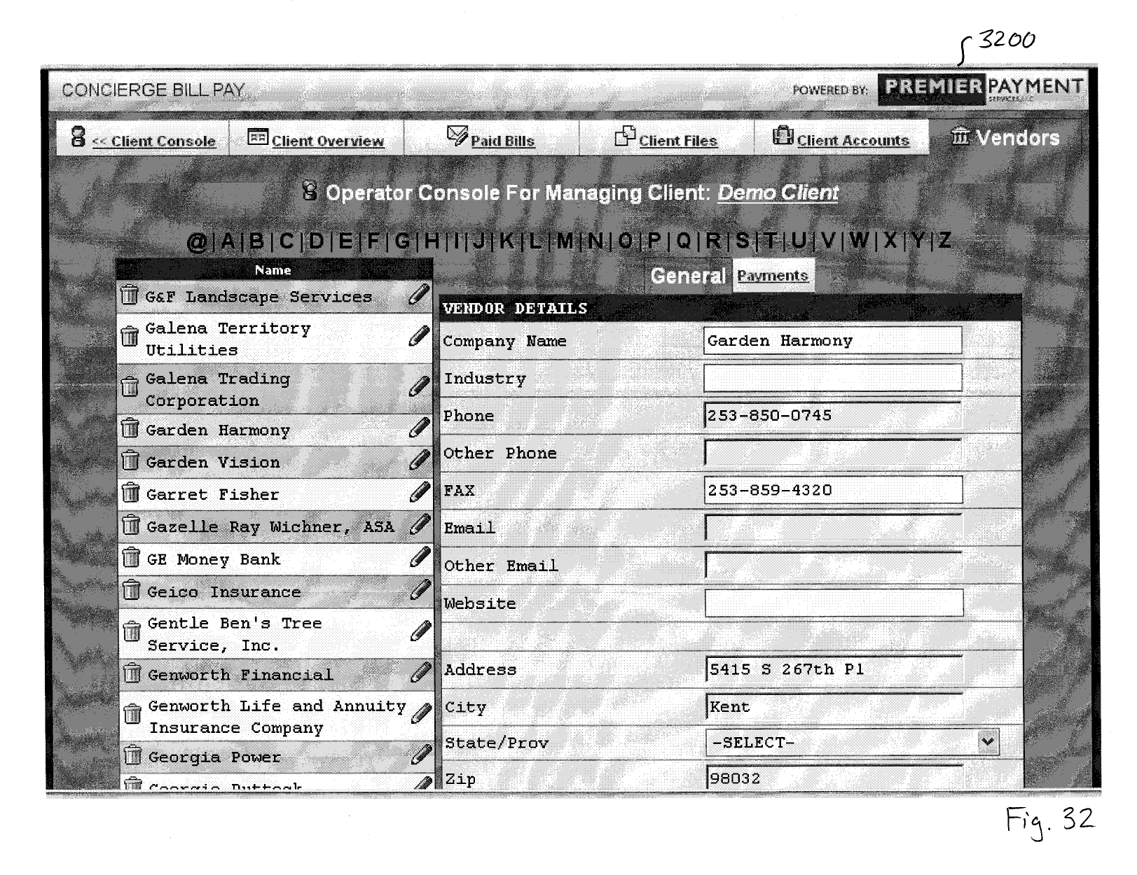

FIG. 29 depicts a web page 2900 that the system may provide to an operator to enable the operator to manage bill paying for groups of individuals, such as clients of the operator. The web page 2900 includes links that enable an operator to select a client, view and manage client information, view and manage client files, view and manage accounts of the client, view and manage client vendors and perform other functions. The web page 2900 can also display information on whether or not a client bill should be payable based on the results of the payable bill algorithm. FIG. 30 depicts a web page 3000 that provides information on bills paid over a particular period of time, such as one year. The operator can view whether or not bills were paid on a monthly or other (e.g., weekly, quarterly, yearly, etc.) basis. FIG. 31 depicts a web page 3100 that enables an operator to manage client documents, such as scanned bills. The web page 3100 enables an operator to load scanned bills and view previously-loaded scanned bills, on a monthly or other (e.g., weekly, quarterly, yearly, etc.) basis. The web page 3100 also enables the operator to provide reports created on a monthly or other (e.g., weekly, quarterly, yearly, etc.) basis to the client for the client's access. FIG. 32 depicts a web page 3200 that enables an operator to view and manage vendors associated with one or more clients. The web page 3200 displays vendors in alphabetical format and displays detailed information about each vendor, such as the vendor name, the vendor contact information, and payments (either on an individual client or groups of client basis) to the vendor.

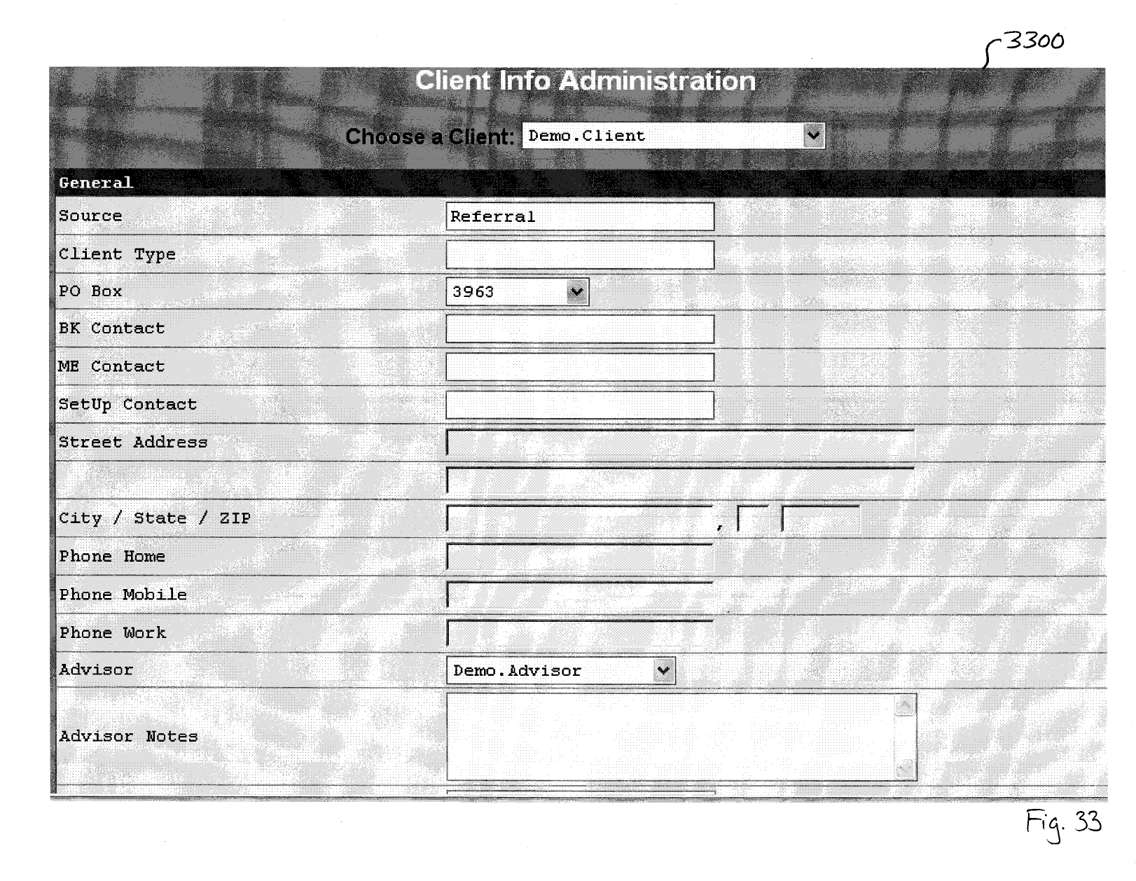

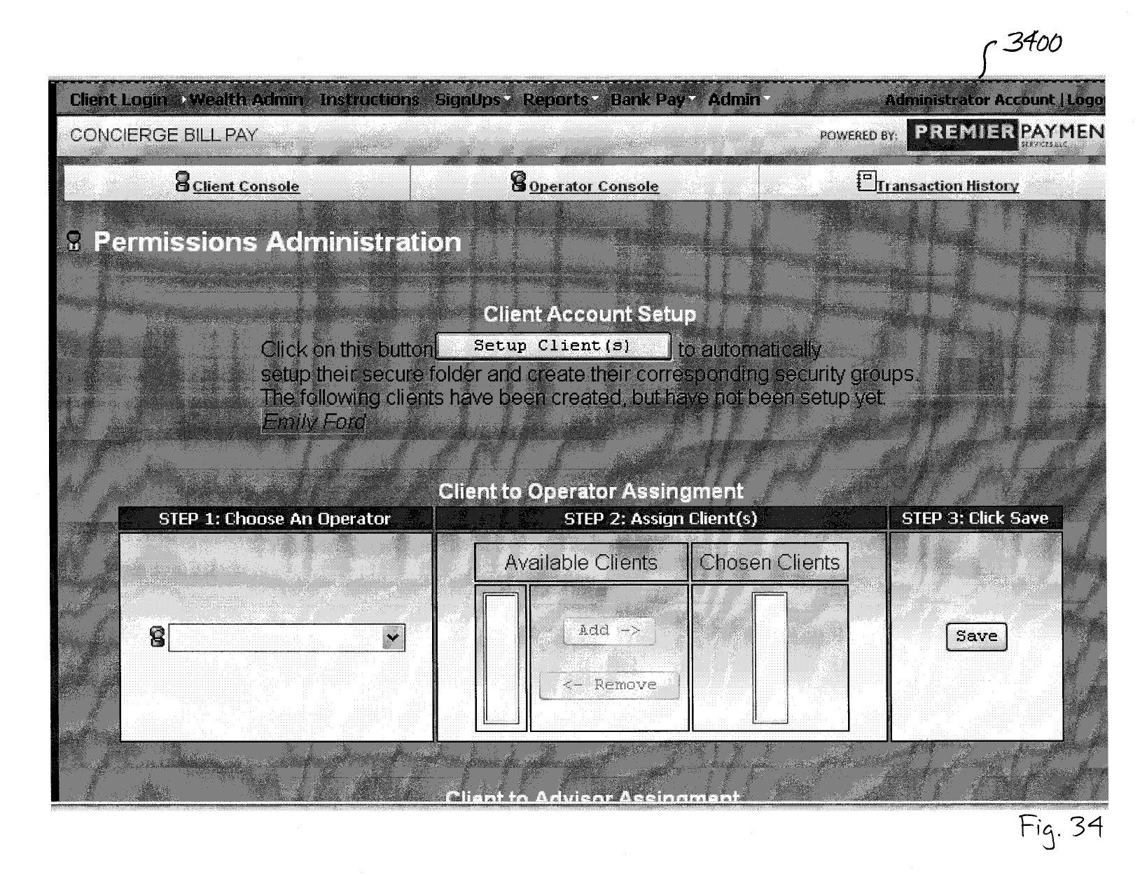

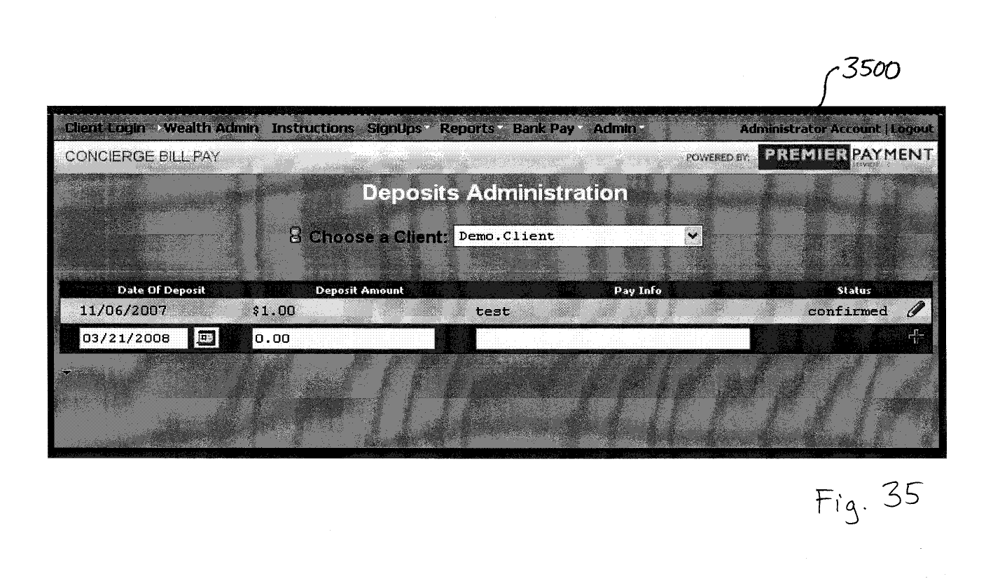

FIG. 33 depicts a web page 3300 that enables an operator to view and manage information associated with a client. The operator can view, input, edit and/or delete information about the client, such as the client name, the client contact information, the client adviser, and other information. FIG. 34 depicts a web page 3400 that enables an administrator to associate one or more clients with one or more operators. The web page 3400 also includes links that enable an administrator to perform various reporting and auditing functions. FIG. 35 depicts a web page 3500 that enables a user to view and manage connections to banks and other financial services institutions. The web page 3500 includes links that enable the user to view and manage available client funds, view and manage bill payments, and view and manage reports on bill payments. The bill paying system can connect to banking institutions directly to deposit and withdraw funds or can use an intermediary such as a third-party payment processor (e.g., an institution that processes checks or Automatic Clearing House (ACH) payments).

### CONCLUSION

Unless the context clearly requires otherwise, throughout the description and the claims, the words “comprise,” “comprising,” and the like are to be construed in an inclusive sense, as opposed to an exclusive or exhaustive sense; that is to say, in the sense of “including, but not limited to.” As used herein, the terms “connected,” “coupled,” or any variant thereof, means any connection or coupling, either direct or indirect, between two or more elements; the coupling of connection between the elements can be physical, logical, or a combination thereof. Additionally, the words “herein,” “above,” “below,” and words of similar import, when used in this application, shall refer to this application as a whole and not to any particular portions of this application. Where the context permits, words in the above Detailed Description using the singular or plural number may also include the plural or singular number respectively. The word “or,” in reference to a list of two or more items, covers all of the following interpretations of the word: any of the items in the list, all of the items in the list, and any combination of the items in the list.

The above detailed description of embodiments of the invention is not intended to be exhaustive or to limit the invention to the precise form disclosed above. While specific embodiments of, and examples for, the invention are described above for illustrative purposes, various equivalent modifications are possible within the scope of the invention, as those skilled in the relevant art will recognize. For example, while processes or blocks are presented in a given order, alternative embodiments may perform routines having steps, or employ systems having blocks, in a different order, and some processes or blocks may be deleted, moved, added, subdivided, combined, and/or modified to provide alternative or subcombinations. Each of these processes or blocks may be implemented in a variety of different ways. Also, while processes or blocks are at times shown as being performed in series, these processes or blocks may instead be performed in parallel, or may be performed at different times. Further any specific numbers noted herein are only examples: alternative implementations may employ differing values or ranges.

The teachings of the invention provided herein can be applied to other systems, not necessarily the system described above. The elements and acts of the various embodiments described above can be combined to provide further embodiments.

Any patents and applications and other references noted above, including any that may be listed in accompanying filing papers, are incorporated herein by reference. Aspects of the invention can be modified, if necessary, to employ the systems, functions, and concepts of the various references described above to provide yet further embodiments of the invention.

These and other changes can be made to the invention in light of the above Detailed Description. While the above description describes certain embodiments of the invention, and describes the best mode contemplated, no matter how detailed the above appears in text, the invention can be practiced in many ways. Details of the system may vary considerably in its implementation details, while still being encompassed by the invention disclosed herein. As noted above, particular terminology used when describing certain features or aspects of the invention should not be taken to imply that the terminology is being redefined herein to be restricted to any specific characteristics, features, or aspects of the invention with which that terminology is associated. In general, the terms used in the following claims should not be construed to limit the invention to the specific embodiments disclosed in the specification, unless the above Detailed Description section explicitly defines such terms. Accordingly, the actual scope of the invention encompasses not only the disclosed embodiments, but also all equivalent ways of practicing or implementing the invention under the claims.

While certain aspects of the invention are presented below in certain claim forms, the inventors contemplate the various aspects of the invention in any number of claim forms. For example, while only one aspect of the invention is recited as a means-plus-function claim under 35 U.S.C § 112, sixth paragraph, other aspects may likewise be embodied as a means-plus-function claim. (Any claims intended to be treated under 35 U.S.C. § 112, ¶6 will begin with the words “means for”.) Accordingly, the inventors reserve the right to add additional claims after filing the application to pursue such additional claim forms for other aspects of the invention.

I/We claim:

1. A computer-implemented method of paying a bill on behalf of a user, the method comprising:
receiving a bill from a vendor for a user, wherein the bill includes an identifier of the user, an identifier of the vendor, and an amount of the bill;
obtaining the user identifier, the vendor identifier, and the bill amount from the bill;
associating the bill with the user based on the user identifier;
associating the bill with the vendor based on the vendor identifier;
determining whether the bill is payable, wherein determining whether the bill is payable includes comparing the bill to stored bill data associated with the user and the vendor; and
when the bill is payable:
obtaining funds from an account of the user and dispersing funds to the vendor to pay the bill; and
storing an indication of the paying of the bill.

2. The computer-implemented method of claim 1, further comprising when the bill is not payable:
contacting the vendor regarding the bill; and
providing an indication to the user of the contact with the vendor.

3. The computer-implemented method of claim 1 wherein determining whether the bill is payable further includes determining whether a dispute exists between the user and the vendor.

4. The computer-implemented method of claim 1, further comprising receiving a rule regarding the paying of the bill, and wherein determining whether the bill is payable further includes:
determining whether paying the bill would violate the rule; and
if paying the bill would violate the rule, storing an indication that the paying of the bill would violate the rule.

5. The computer-implemented method of claim 1 wherein comparing the bill to stored bill data associated with the user and the vendor includes comparing the amount of the bill to an amount of a previously-paid bill from the vendor to the user.

6. The computer-implemented method of claim 1, further comprising receiving a criterion against which the bill is to be evaluated, and wherein determining whether the bill is payable further includes evaluating the bill against the criterion.

7. The computer-implemented method of claim 6 wherein receiving the criterion against which the bill is to be evaluated includes receiving the criterion from the user.

8. The computer-implemented method of claim 1 wherein receiving the bill from the vendor to the user includes receiving a paper bill from the vendor to the user, and wherein the method further comprises:
scanning the paper bill; and
producing a digital image of the paper bill,
wherein obtaining the user identifier, the vendor identifier, and the bill amount from the bill includes performing Optical Character Recognition (OCR) on the digital image to extract the user identifier, the vendor identifier and the bill amount.

9. The computer-implemented method of claim 1, further comprising:
receiving authorization from the user to provide to the vendor a new address for bills to the user; and
providing the new address to the vendor,
wherein receiving the bill from the vendor to the user includes receiving at the new address the bill from the vendor to the user.

10. The computer-implemented method of claim 1, further comprising providing a report to the user, wherein the report includes the indication of the paying of the bill.

11. The computer-implemented method of claim 1, wherein the bill is a first bill, the user is a first user, and wherein the method further comprises:
receiving a second bill from the vendor to the user;
determining whether the second bill is payable, wherein determining whether the second bill is payable includes comparing the second bill to stored bill data associated with the second user and the vendor; and
calculating a vendor rating for the vendor based at least in part on whether the first and second bills are payable.

12. The computer-implemented method of claim 1, wherein the bill is a first bill, the vendor is a first vendor, the indication is a first indication, and wherein the method further comprises:
receiving a second bill from a second vendor to the user, wherein the second bill includes an identifier of the user, an identifier of the second vendor, and an amount of the second bill;
obtaining the user identifier, the second vendor identifier, and the second bill amount from the second bill;
associating the second bill with the user based on the user identifier;
associating the second bill with the second vendor based on the second vendor identifier;
determining whether the second bill is payable, wherein determining whether the second bill is payable includes comparing the second bill to stored bill data associated with the user and the second vendor; and
when the second bill is payable:
transferring funds from an account of the user to the second vendor to pay the second bill;
storing a second indication of the paying of the second bill; and
providing an accounting ledger to the user, wherein the accounting ledger includes the first and second indications of the paying of the first and second bills.

13. A computing system for paying bills, the computing system comprising:
a processor; and
a computer-readable medium operably coupled to the processor and including instructions that when executed by the processor cause the computing system to perform a method of paying a bill on behalf of a user, the method comprising:
receiving a bill from a vendor for a user, wherein the bill includes an identifier of the user, an identifier of the vendor, and an amount of the bill;
obtaining the user identifier, the vendor identifier, and the bill amount from the bill;
associating the bill with the user based on the user identifier;
associating the bill with the vendor based on the vendor identifier;
determining whether the bill is payable, wherein determining whether the bill is payable includes comparing the bill to stored bill data associated with the user and the vendor; and
when the bill is payable:
transferring funds from an account of the user to the vendor to pay the bill; and
storing an indication of the paying of the bill.

14. The computing system of claim 13 wherein the method further comprises when the bill is not payable:
contacting the vendor regarding the bill; and
providing an indication to the user of the contact with the vendor.

15. The computing system of claim 13 wherein determining whether the bill is payable further includes determining whether a dispute exists between the user and the vendor.

16. The computing system of claim 13 wherein the method further comprises receiving a rule regarding the paying of the bill, and wherein determining whether the bill is payable further includes:
determining whether paying the bill would violate the rule; and
if paying the bill would violate the rule, storing an indication that the paying of the bill would violate the rule.

17. The computing system of claim 13, further comprising:
a scanning component operably coupled to the processor; and
an Optical Character Recognition (OCR) component operably coupled to the processor and the scanning component,
wherein receiving the user bill from the vendor includes receiving from the vendor a paper bill, and wherein the method further comprises scanning the paper bill with the scanning component to produce a digital image of the paper bill, and wherein obtaining the user identifier, the vendor identifier and the bill amount from the bill includes performing OCR on the digital image with the OCR component to extract the user identifier, the vendor identifier and the bill amount.

18. The computing system of claim 13 wherein the method further comprises:
receiving authorization from the user to provide to the vendor a new address for bills to the user; and
providing the new address to the vendor,
wherein receiving the bill from the vendor to the user includes receiving at the new address the bill from the vendor to the user.

19. A computing system for the payment of bills, the computing system comprising:
means for receiving a bill from a vendor to a user;
means for extracting information from the bill;
means for determining whether the bill is payable;
means for transferring funds from an account of the user to the vendor; and
means for storing an indication of the funds transfer.

20. The computing system of claim 19, further comprising means for providing a report to the user, wherein the report includes the indication of the funds transfer.
